(19) United States
(12) Patent Application Publication
(10) Pub. No.: US 2022/0212420 A1
(43) Pub. Date: Jul. 7, 2022

(54) MULTI-COMPOUND FIBER REINFORCED COMPOSITES AND METHODS OF MAKING THE SAME USING FRONTAL POLYMERIZATION AND TARGETED PHOTOSENSITIZER ADDITIVES

(71) Applicant: GM GLOBAL TECHNOLOGY OPERATIONS LLC, Detroit, MI (US)

(72) Inventor: Bradley A. NEWCOMB, Troy, MI (US)

(73) Assignee: GM GLOBAL TECHNOLOGY OPERATIONS LLC, Detroit, MI (US)

(21) Appl. No.: 17/140,437

(22) Filed: Jan. 4, 2021

(51) Int. Cl. B29C 70/08; C08K 5/07; C08K 5/45; C08K 5/02; B29C 70/30; C08L 57/00; C08L 87/00

(52) U.S. Cl. CPC B29C 70/086; C08K 5/07; C08K 5/45; B29K 2301/00; B29C 70/30; C08L 57/00; C08L 87/00; C08K 5/02

(57) ABSTRACT

The present disclosure relates to multi-compound fiber reinforced composites and methods of making the same using frontal polymerization and targeted photosensitizer additives. In various aspects, the method may include disposing one or more layers in a mold cavity, where each of the one or more layers includes a fiber material and a first compound. The method may further includes disposing a second compound in the mold cavity, where the second compound includes a photosensitizer material. Further still, the method may include initiating photopolymerization of the photosensitizer using an ultraviolet light source, removing ultraviolet light source, and/or completing polymerization of the one or more layers so as to form the fiber-reinforced composite.

### INTRODUCTION

This section provides background information related to the present disclosure which is not necessarily prior art.

Light-weight polymeric components, such as reinforced composite materials, have been considered for use as structural and load-carrying components in vehicles. Often such polymeric materials are manufactured by compression molding. However, compression molding, and other similar approaches, to the manufacture of structural composites can be time and energy intensive. Accordingly, it would be desirable to develop methods of preparing reinforced composite materials that are lower in cost and reduce or improve time and energy requirements necessary during the manufacturing process.

### SUMMARY

This section provides a general summary of the disclosure, and is not a comprehensive disclosure of its full scope or all of its features.

The present disclosure relates to multi-compound fiber reinforced composites and methods of making the same using frontal polymerization and targeted photosensitizer additives.

In various aspects, the present disclosure relates to a method for forming a fiber-reinforced composite. The method may include disposing one or more layers in a mold cavity, where each of the one or more layers includes a fiber material and a first compound. The method may further include disposing a second compound in the mold cavity, where the second compound includes a photosensitizer material. Further still, the method may include initiating photopolymerization of the photosensitizer using an ultraviolet light source, removing ultraviolet light source, and completing polymerization of the one or more layers so as to form the fiber-reinforced composite.

In one aspect, disposing the one or more layers may include disposing the fiber material in the mold cavity and infusing the fiber material with the first compound.

In one aspect, the fiber material may include a first fiber material and a second fiber material, and the first compound may include a first composition and a second composition.

In one aspect, disposing the one or more layers may include disposing the first fiber material in the mold cavity, infusing the first fiber material with the first composition, disposing the second fiber material in the mold cavity, and infusing the second fiber material with the second composition.

In one aspect, the first and second fiber materials may be the same or different.

In one aspect, the first and second compositions may be the same or different.

In one aspect, the fiber material may be selected from carbon fibers, glass fibers, poly paraphenylene terephthalamide fibers, ultra-high molecular weight polyethylene (“UHWMPE”) fibers, basalt fibers, natural fibers, and combinations thereof.

In one aspect, the first compound may include greater than or equal to about 0.1 mol % to less than or equal to about 10 mol % of a thermal initiator; greater than or equal to about 20 mol % to less than or equal to about 99 mol % of a monomer; greater than or equal to about 0 mol % to less than or equal to about 10 mol % of a cationic photoinitiator; and greater than or equal to about 0 mol % to less than or equal to about 70 mol % of a diluent.

In one aspect, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In one aspect, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

In one aspect, the cationic photoinitiator may be selected from the group consisting of:

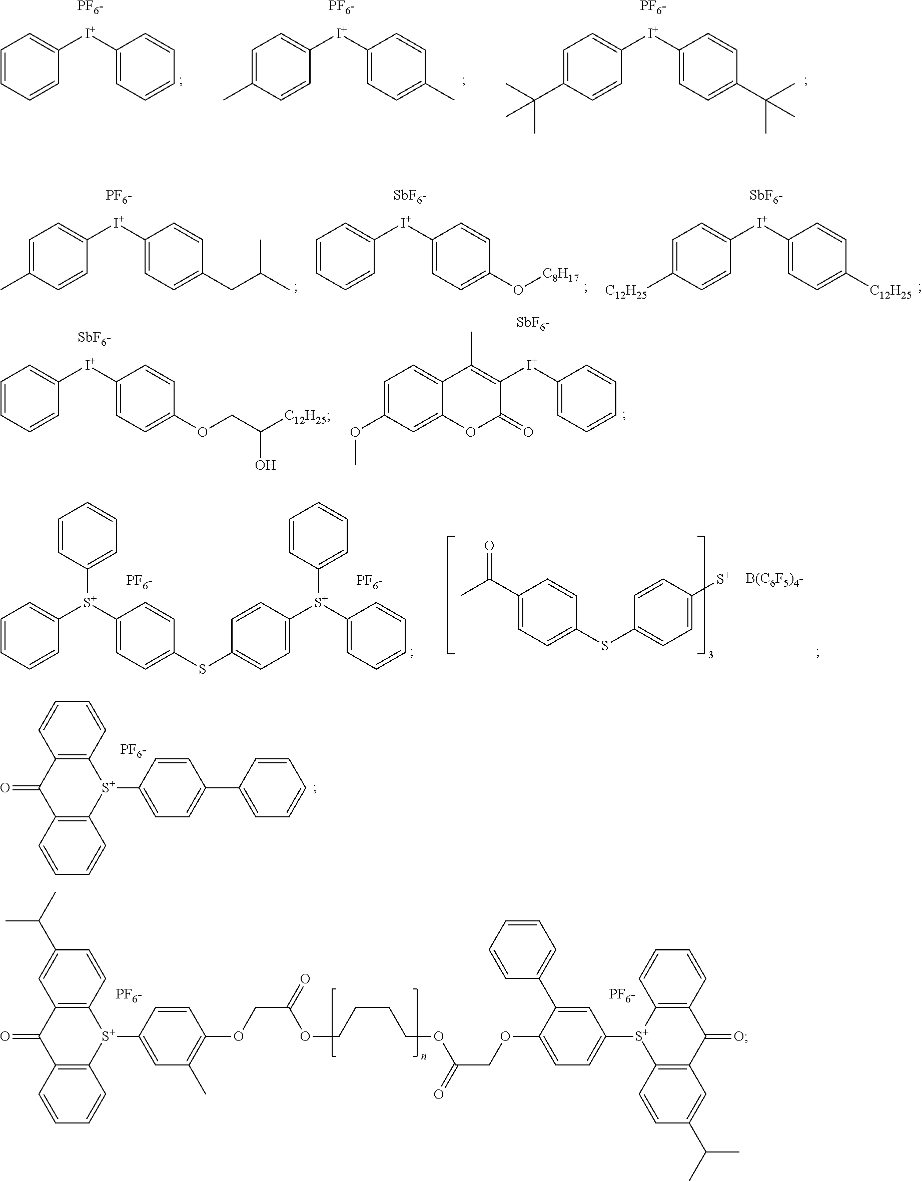

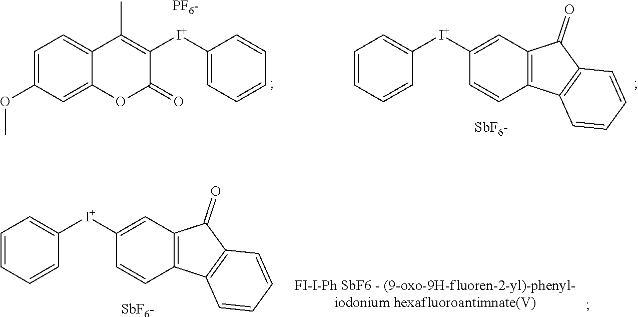

and combinations thereof.

In one aspect, the diluent may be selected from the group consisting of: polyfunctional glycidyl ethers, monofunctional aliphatic glycidyl ethers, monofunctional aromatic glycidyl ethers, 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), and combinations thereof.

In one aspect, the fiber material may be a first fiber material and the method may further include disposing a second fiber material in the mold cavity on or adjacent to the one or more layers.

In one aspect, disposing the second compound may include infusing the second fiber material with the second compound.

In one aspect, the second compound may include greater than or equal to about 0.1 mol % to less than or equal to about 5 mol % of a photosensitizer material.

In one aspect, the photosensitizer material may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

In one aspect, the second compound may further include greater than or equal to about 0.1 mol % to less than or equal to about 10 mol % of a thermal initiator; greater than or equal to about 20 mol % to less than or equal to about 99 mol % of a monomer; greater than or equal to about 0 mol % to less than or equal to about 10 mol % of a cationic photoinitiator; and greater than or equal to about 0 mol % to less than or equal to about 70 mol % of an optional diluent.

In one aspect, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In one aspect, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

In one aspect, the cationic photoinitiator may be selected from the group consisting of:

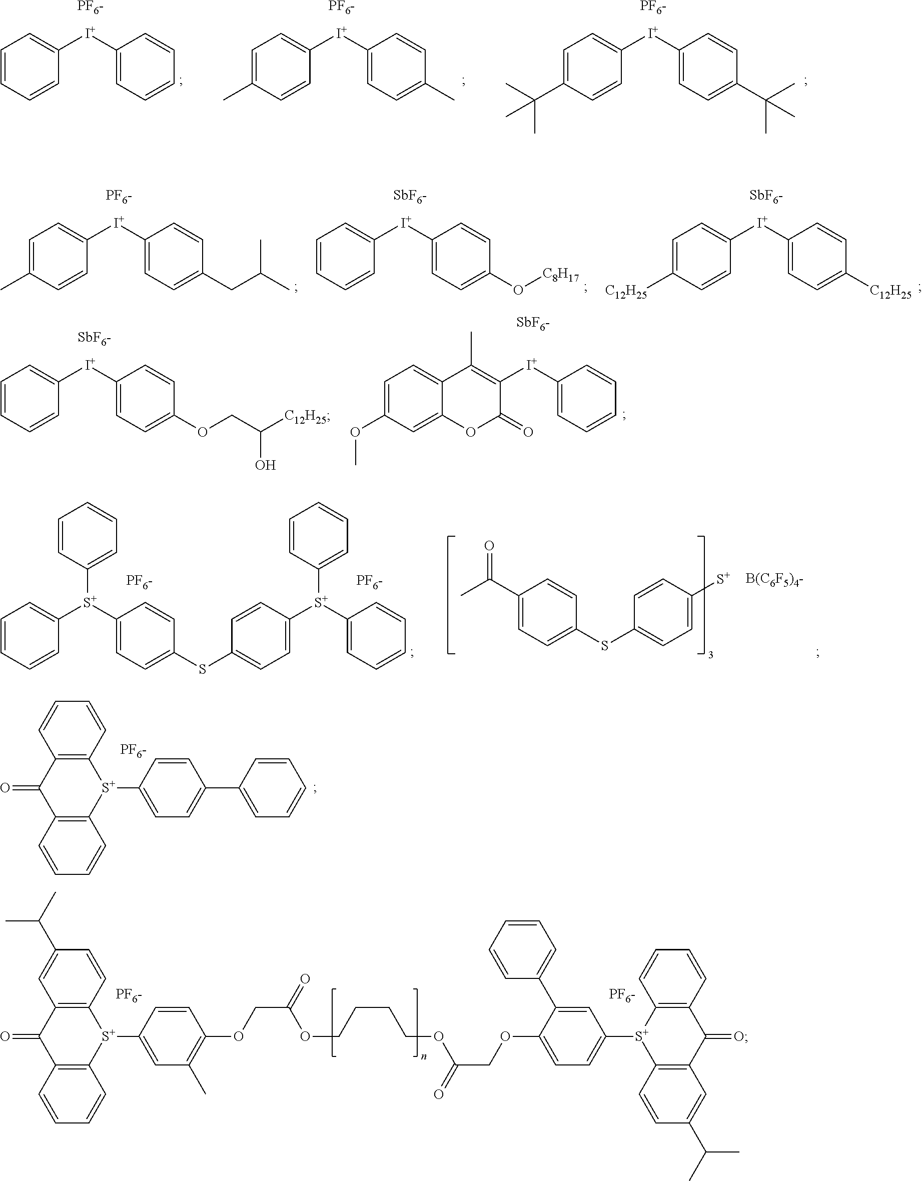

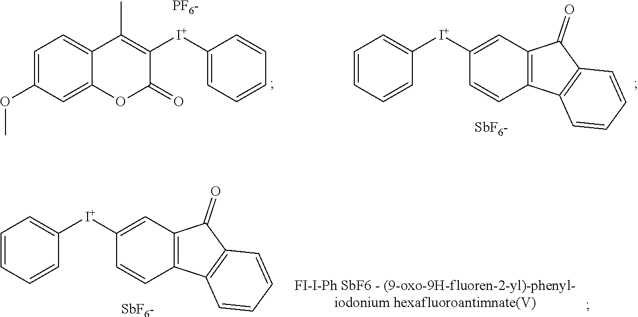

and combinations thereof; and

In one aspect, the diluent may be selected from the group consisting of: polyfunctional glycidyl ethers, monofunctional aliphatic glycidyl ethers, monofunctional aromatic glycidyl ethers, 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), and combinations thereof.

In one aspect, the method may further include removing the fiber-reinforced composite from the mold cavity.

In various aspects, the present disclosure provides a method for forming a fiber-reinforced composite. The method may include disposing a second compound include a photosensitizer material in a mold cavity. The mold cavity may include one or more layers, and each of the one or more layers may include a fiber material and a first compound. The method may further include initiating photopolymerization of the sensitizer using an ultraviolet light source, removing ultraviolet light source, and completing polymerization of the one or more layers so as to form the fiber-reinforced composite.

In one aspect, the fiber material may be a first fiber material and the method may further include disposing a second fiber material in the mold cavity on or adjacent to the one or more layers.

In one aspect, disposing the second compound may include infusing the second fiber material with the second compound.

In one aspect, the method may further include disposing the one or more layers in the mold cavity.

In one aspect, disposing the one or more layers may include disposing the fiber material in the mold cavity, and infusing the fiber material with the first compound.

In one aspect, the fiber material may include a first fiber material and a second fiber material. The first compound may include a first composition and a second composition.

In one aspect, the method further includes disposing the one or more layers in the mold cavity.

In one aspect, disposing the one or more layers may include disposing the first fiber material in the mold cavity, infusing the first fiber material with the first composition, disposing the second fiber material in the mold cavity, and infusing the second fiber material with the second composition.

In one aspect, the first and second fiber materials may be the same or different, and the first and second compositions may be the same or different.

In one aspect, the second compound may include greater than or equal to about 0.1 mol % to less than or equal to about 5 mol % of a photosensitizer material; greater than or equal to about 0.1 mol % to less than or equal to about 10 mol % of a thermal initiator; greater than or equal to about 20 mol % to less than or equal to about 99 mol % of a monomer; greater than or equal to about 0 mol % to less than or equal to about 10 mol % of a cationic photoinitiator; and greater than or equal to about 0 mol % to less than or equal to about 70 mol % of an optional diluent.

In one aspect, the first compound may include greater than or equal to about 0.1 mol % to less than or equal to about 10 mol % of a thermal initiator; greater than or equal to about 20 mol % to less than or equal to about 99 mol % of a monomer; greater than or equal to about 0 mol % to less than or equal to about 10 mol % of a cationic photoinitiator; and greater than or equal to about 0 mol % to less than or equal to about 70 mol % of an optional diluent.

In various aspects, the present disclosure provides a fiber-reinforced composite. The fiber-reinforced composite may include one or more layers, where each of the one or more layers includes a fiber material and a first compound. The fiber-reinforced composite may further include a second compound disposed on or adjacent to the one or more layers. The second compound may include a photosensitizer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a cross-section illustration of an example fiber-reinforced composite prepared in accordance with various aspects of the current technology;

FIGS. 2A-2J illustrate an example method for forming a fiber-reinforced composite in accordance with various aspects of the current technology;

FIGS. 3A-3I illustrate another example method for forming a fiber-reinforced composite in accordance with various aspects of the current technology;

FIGS. 4A-4G illustrate another example method for forming a fiber-reinforced composite in accordance with various aspects of the current technology;

FIGS. 5A-5F illustrate another example method for forming a fiber-reinforced composite in accordance with various aspects of the current technology;

FIG. 6 illustrates an example pressure adding process for use in the formation of a fiber-reinforced composite in accordance with various aspects of the current technology; and

FIG. 7 illustrates another example pressure adding process for use in the formation of a fiber-reinforced composite in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

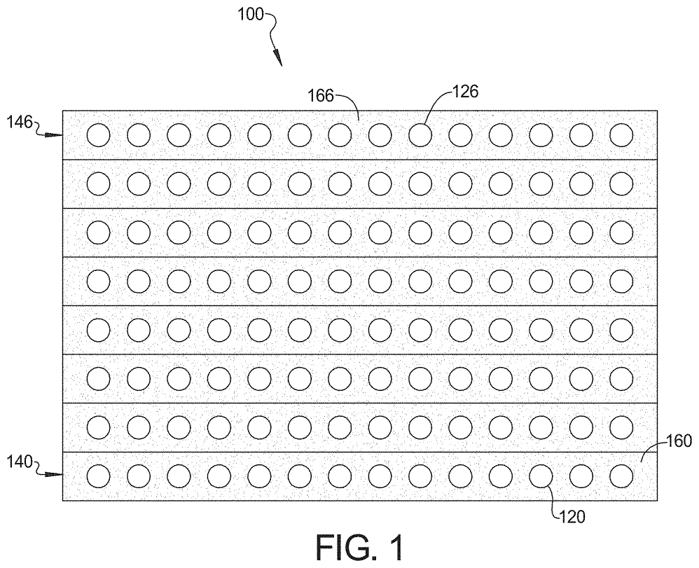

FIG. 1 is a cross-section illustration of an example fiber-reinforced composite 100. The fiber-reinforced composite 100 includes a plurality of rows or layers. The plurality of rows or layers includes one or more first layers 140 and at least one second layer 146. For example, as illustrated, the fiber-reinforced composite 100 may include seven stacked first layers 140 and a second layer 146 disposed on or adjacent to an exposed surface of a first end of the stack of first layers 140. Each of the first layers 140 includes a first fiber material 120 and a first compound 160. The second layer 146 includes a second fiber material 126 and a second compound 166.

The first and second fiber materials may be the same or different. In certain variations, the first and second fiber materials 120 may each includes one or more short or continuous fibers. The continuous fibers may be woven (e.g., twill weaved, 5 harness satin, 8 harness satin), non-crimp fabrics, or unidirectional, also including fibers, fiber tows, and fiber tapes. For example, the first fiber material 120 and the second fiber material 126 may each be independently selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

In certain variations, the first compound 160 includes a thermal initiator and a monomer. In other variations, the first compound 160 includes a thermal initiator, a monomer, and a cationic photoinitiator. In each instance, the first compound 160 optionally includes a diluent. For example, the first compound 160 includes greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The second compound 166 includes a photosensitizer. For example, in certain variations, the second compound 166 includes a thermal initiator, a monomer, and a photosensitizer. In other variations, the second compound 166 includes a thermal initiator, a monomer, a cationic photoinitiator, and a photosensitizer. In each instance, the second compound 166 optionally includes a diluent. For example, the second compound 166 includes greater than or equal to about 0.1 mol % to less than or equal to about 5 mol % of the photosensitizer; greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The thermal initiator, monomer, and/or cationic photoinitiator of the second compound 166 may be the same or different from the thermal initiator, monomer, and/or cationic photoinitiator of the first compound 160.

In certain variations, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In certain variations, the monomer includes one or more epoxy thermoset resins, such as diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE′ resin 827, and the like. In other variations, the monomer includes one or more open ring-opening polymerization monomers. In still over variations, the monomer includes non-cyclic monomers, such as vinyl ethers.

In each instance, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

The cationic photoinitiator may be suitable for frontal polymerization. For example, in certain variations, the cationic photoinitiator includes one or more photoacid generators (“PAGs”), such as those represented by the following formulas (including the respective trade names and businesses from which such compounds are commercially available, as well as a wavelength of maximum absorbance for UV-Visible Spectroscopy, designated as λₘₐₓ, where applicable):

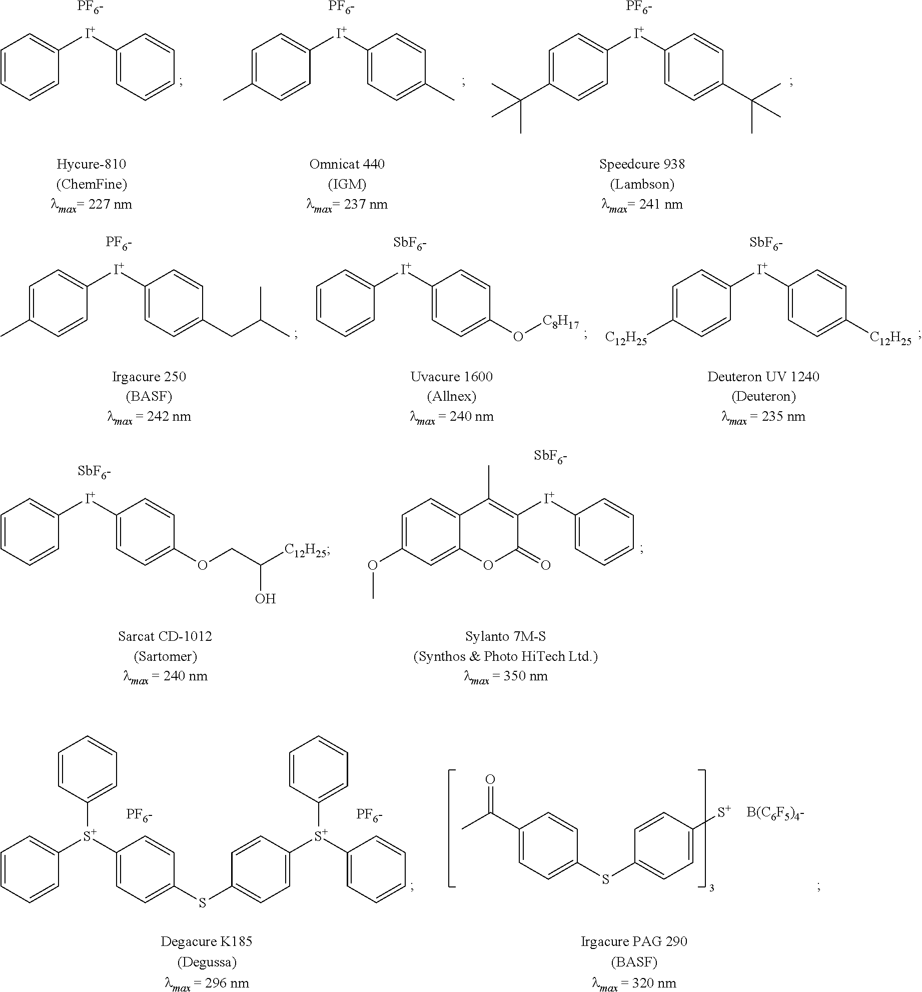

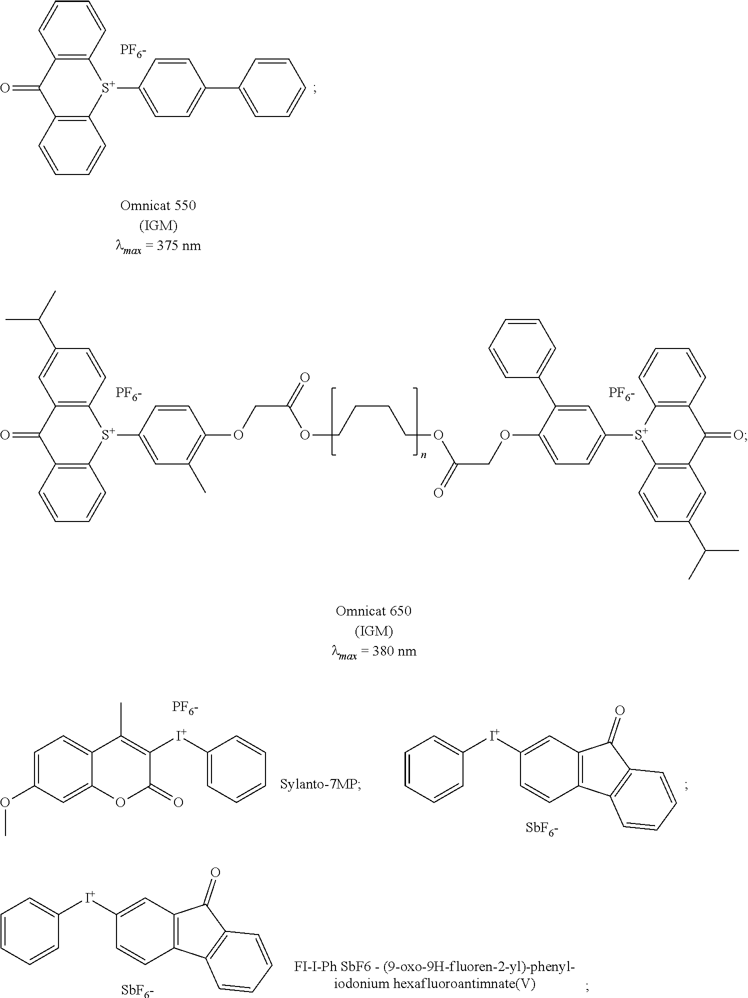

the like, and combinations thereof.

In certain variations, the diluent includes polyfunctional glycidyl ethers (such as, HELOXY™ 107, HELOXY™ 48, HELOXY™ 68, and the like), monofunctional aliphatic glycidyl ethers (such as, HELOXY™ 166, HELOXY™ 61, and the like), monofunctional aromatic glycidyl ethers (such as HELOXY™ 62 and the like), 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), the like and combinations thereof.

In certain variations, the photosensitizer may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

In various aspects, the present disclosure provides methods for forming fiber-reinforced composites (“FRCs”), like fiber-reinforced composite 100, illustrated in FIG. 1. Example methods include disposing one or more fiber materials in a mold cavity and infusing or covering or coating the one or more fiber materials with one or more compounds, where at least one of the one or more compounds includes a photosensitizer. Such methods may further include triggering the photosensitizer so as to induce free radical-induced cationic frontal polymerization (i.e., curing) across the one or more fiber materials. The photosensitizer may be triggered using an ultraviolet light.

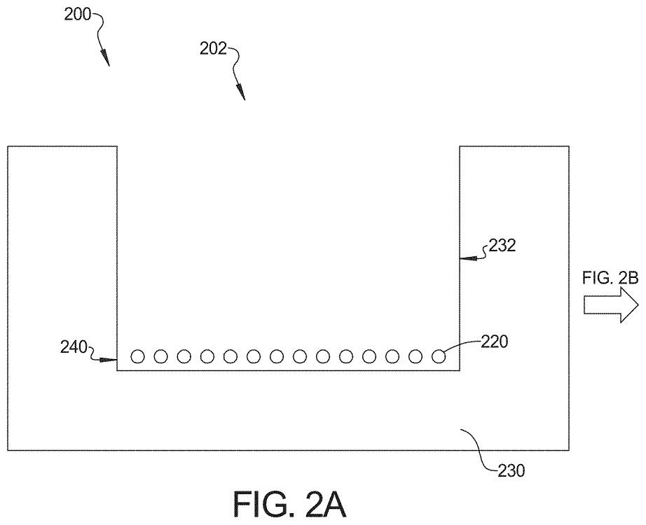

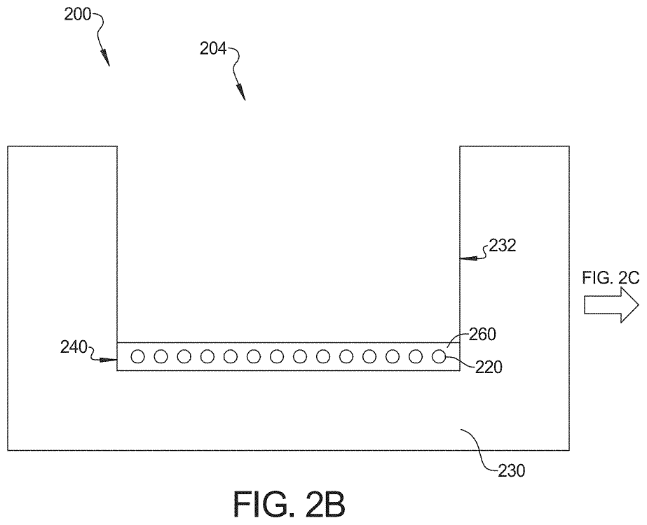

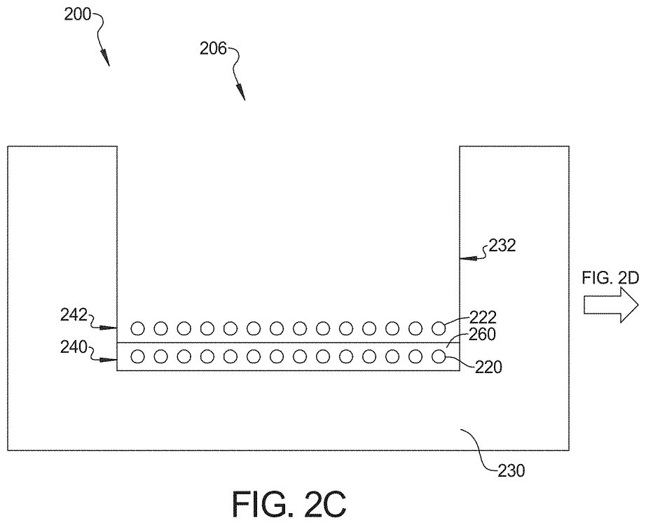

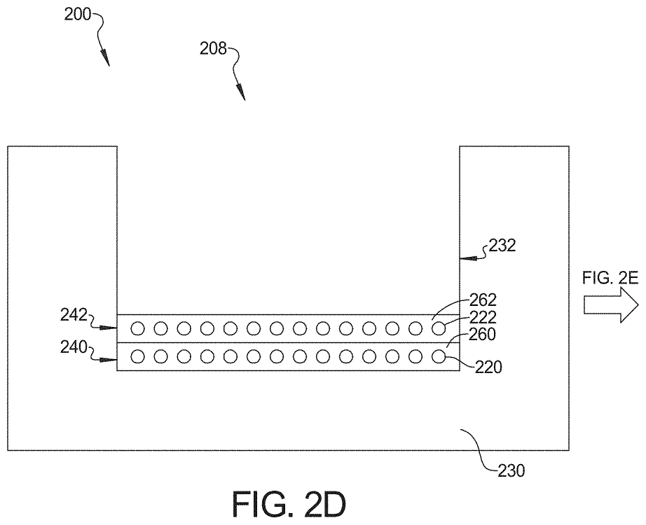

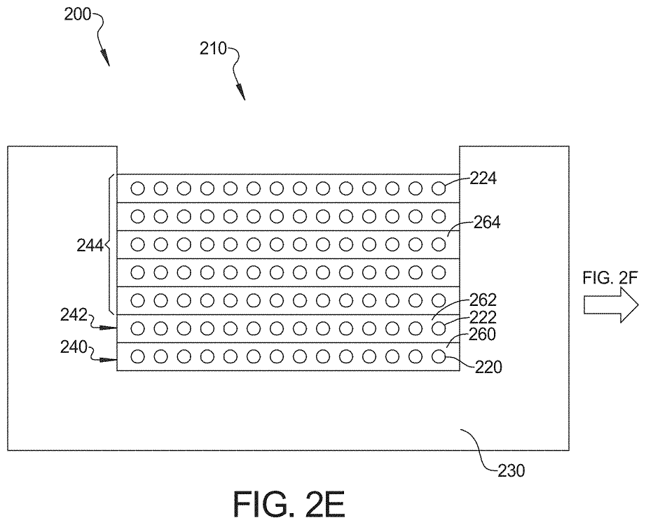

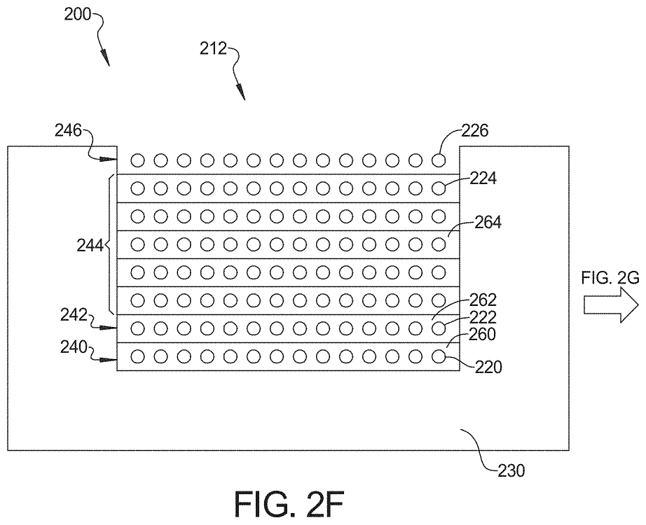

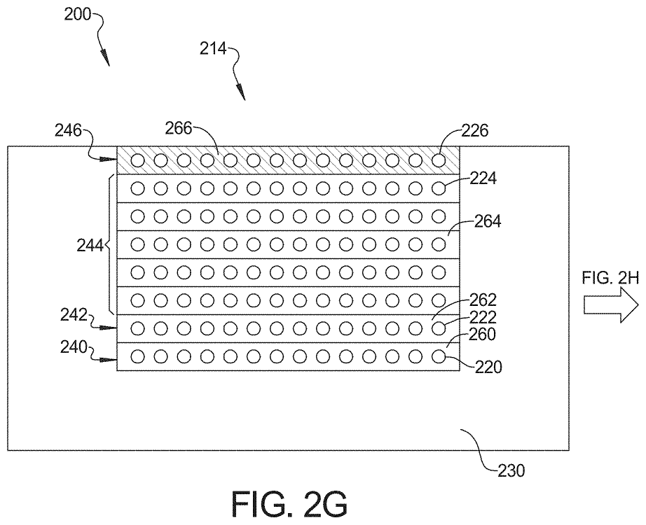

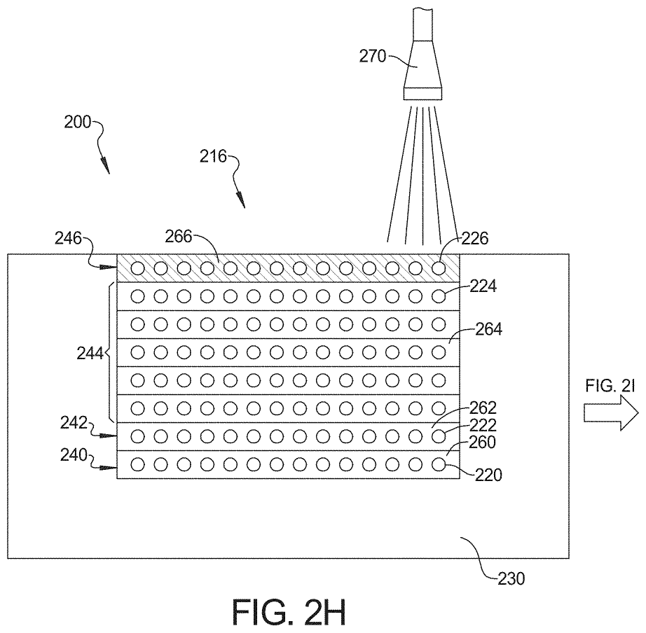

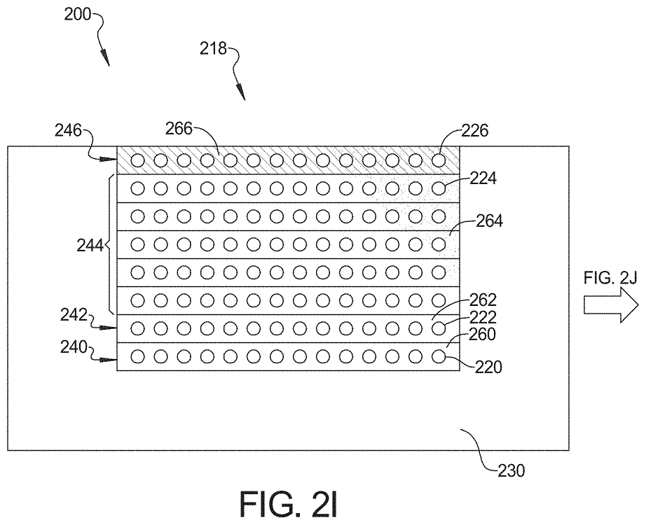

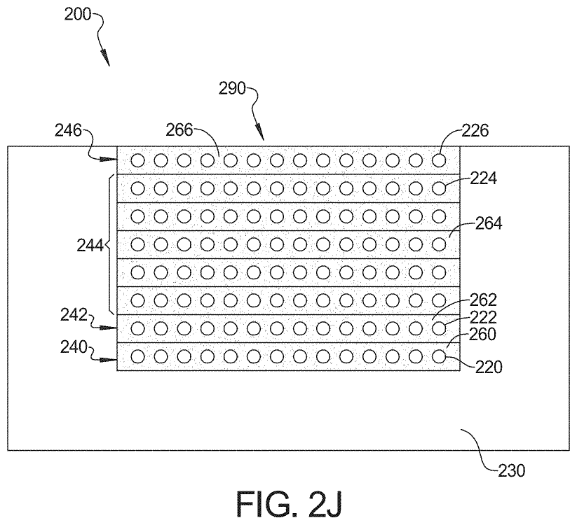

FIGS. 2A-2J illustrate an example method for forming a fiber-reinforced composite 290. The method 200 may be a layer-by-layer process that includes sequentially forming one or more rows or layers 240, 242, 244, 246, where each layer 240, 242, 244, 246 includes one or more fiber materials 220, 222, 224, 226 and a coating compound 260, 262, 264, 266. The coating compound 266 of a last layer 246 includes a photosensitizer

For example, as illustrated, at FIG. 2A, the method 200 includes disposing 202 a first fiber material 220 in a mold cavity 232. In certain instances, the first fiber material 220 may be disposed 202 in the mold cavity 232 using a hand process that is similar to hand layup for pre-impregnated woven materials or dry fabrics (for example, prior to resin infusion) and the like. In other instances, the first fiber material 220 may be disposed 202 in the mold cavity 232 using a robotic process, such as automated tape layup, automated tap placement, automatic fabric layup, automatic fabric placement, and the like.

In each instance, the first fiber material 220 defines a first row or layer 240. Though horizontal rows and layers 240 are illustrated, various other shapes and configurations would be recognized by the skilled artisan, including, for example only, vertical rows. Similarly, the skilled artisan will recognize that that the mold 230 and/or mold cavity 232 may have a variety of other shapes and configurations. In certain variations, the mold 230 may include any material having a low thermal conductivity, including, by way of non-limiting example, steel, aluminum, Invar (FeNi₃₆), austenitic nickel-chromium-based superalloys (such as, INCONEL®), high density tooling foam/board, basic polymers (such as, poly(methyl methacrylate) (PMMA), epoxies, and other thermosets or thermoplastics), glass, and the like.

The first fiber material 220 includes one or more short or continuous fibers. The continuous fibers may be woven (e.g., twill weaved, 5 harness satin, 8 harness satin), non-crimp fabrics, or unidirectional, also including fibers, fiber tows, and fiber tapes. For example, the first fiber material 220 may each be selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

As illustrated in FIG. 2B, the method 200 may further include disposing 204 a first compound 260 in the mold cavity 232 so as to infuse or cover or coat the first fiber material 220. The first compound 260 may be disposed 204 using one or more processes including, by way of non-limiting example, a dropwise addition, a resin infusion process, a rolling process, or the like. Infusion processes may support low volume manufacturing and/or high volume manufacturing using, for example, a high pressure resin transfer molding tool (“HP-RTM”). In certain aspects, a consolidating process can be used that includes pouring the first compound 260 on top of the dry first fiber material 220 and using a roller to spread the first compound 260 across the entire surface of the first fiber material 220. Such may occur with a thin film placed between the roller and the first compound 260 and the first fiber material 220 so that the roller stays dry of first fiber material 220. After the rolling is done, the film may be removed and reused for the next layer(s). In other aspects, the first fiber material 220 may be passed through a resin bath. The first fiber material 220 in a resin bath that includes the first compound 260 prior to being disposed in the mold cavity 232. In each instances, the process may include spreading a first compound 260 on one or more fiber layers (e.g., first fiber material 220) and/or placing in a resin bath and disposing in the mold cavity one or more fiber layers (e.g., first fiber material 220).

In certain variations, the first compound 260 includes a thermal initiator and a monomer. In other variations, the first compound 260 includes a thermal initiator, a monomer, and a cationic photoinitiator. In each instance, the first compound 260 optionally includes a diluent. For example, the first compound 260 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

In certain variations, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In certain variations, the monomer includes one or more epoxy thermoset resins, such as diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE′ resin 827, and the like. In other variations, the monomer includes one or more open ring-opening polymerization monomers. In still over variations, the monomer includes non-cyclic monomers, such as vinyl ethers.

In each instance, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

The cationic photoinitiator may be suitable for frontal polymerization. For example, in certain variations, the cationic photoinitiator includes one or more photoacid generators (“PAGs”), such as those represented by the following formulas (including the respective trade names and businesses from which such compounds are commercially available, as well as a wavelength of maximum absorbance for UV-Visible Spectroscopy, designated as λₘₐₓ, where applicable):

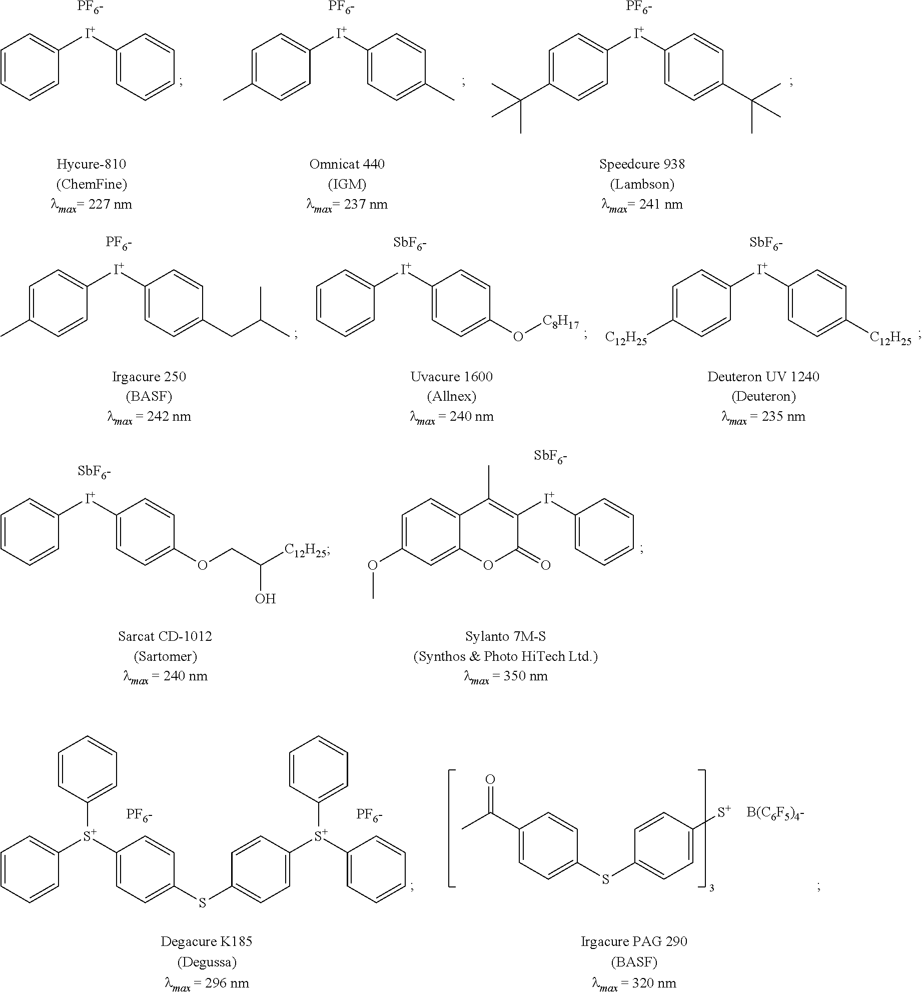

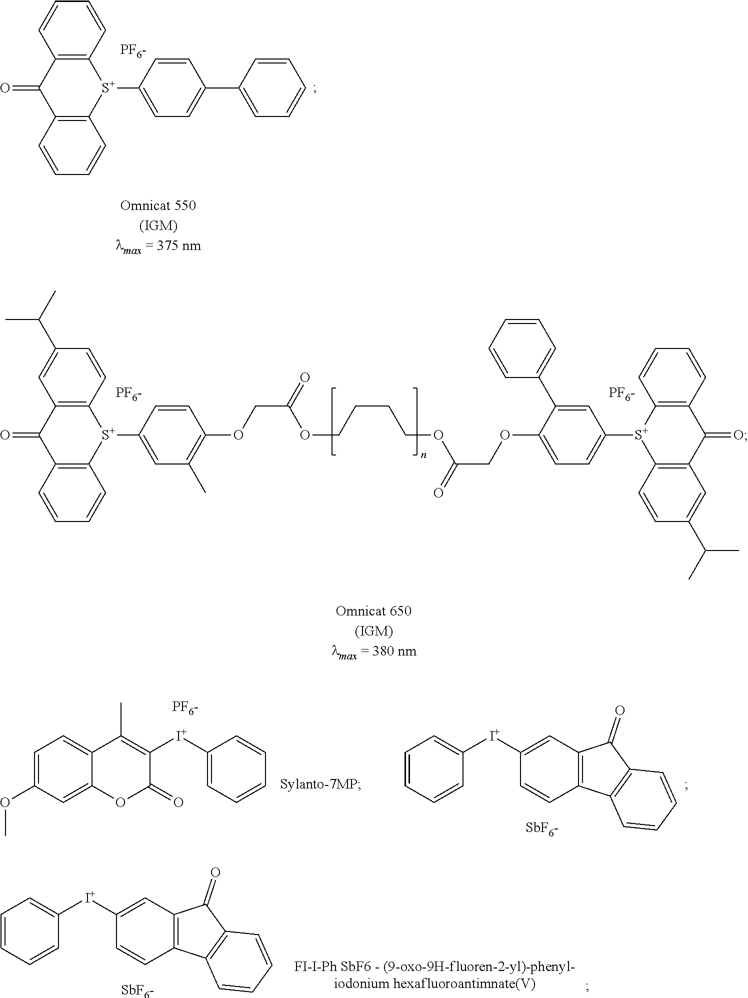

the like and combinations thereof.

In certain variations, the diluent includes polyfunctional glycidyl ethers (such as, HELOXY™ 107, HELOXY™ 48, HELOXY™ 68, and the like), monofunctional aliphatic glycidyl ethers (such as, HELOXY™ 166, HELOXY™ 61, and the like), monofunctional aromatic glycidyl ethers (such as HELOXY™ 62 and the like), 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), the like and combinations thereof.

As illustrated in FIG. 2C, the method 200 may further include disposing 206 a second fiber material 222 in the mold cavity 232. The second fiber material 222 defines a second row or layer 242. As illustrated, the second layer 242 may be disposed 206 on or adjacent to an exposed surface of the first row 240. The second fiber material 222 may be the same as or different from the first fiber material 220. For example, the second fiber material 222 may be selected from carbon fibers, glass fibers, poly paraphenylene terephthalamide fibers (KEVLAR® fibers), ultra-high molecular weight polyethylene (“UHWMPE”) fibers, basalt fibers, natural fibers, the like and combinations thereof. The second fiber material 222 may be disposed using the same process used to dispose the first fiber material 220.

As illustrated in FIG. 2D, the method 200 may further include disposing 208 a second compound 262 in the mold cavity 232 so as to infuse or cover or coat the second fiber material 220. The second compound 262 may be disposed using the same process used to dispose the first compound 260.

The second compound 262 may be the same as or different from the first compound 260. For example, in certain variations, the second compound 262 includes a thermal initiator and a monomer. In other variations, the second compound 262 includes a thermal initiator, a monomer, and a cationic photoinitiator. In each instance, the second compound 262 optionally includes a diluent. Like the first compound 260, the second compound 262 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

As illustrated in FIG. 2E, the method 200 may further include disposing 210 one or more other rows or layers 244 in the mold cavity 232. For example, the method 200 may include subsequently disposing 210 one or more other fiber materials 224 and one or more other compounds 264 in the mold cavity 232, using method similar to those used to form the first layer 240 and/or the second layer 242. As illustrated, the method 200 may include disposing 210 five other layers 244 on or adjacent to an exposed surface of the second row 242.

Each of the one or more other fiber materials 224 may be the same or different from the first fiber material 220 and/or the second fiber material 222. For example, each of the one or more other fiber materials 224 may be independently selected from carbon fibers, glass fibers, poly paraphenylene terephthalamide fibers (KEVLAR® fibers), ultra-high molecular weight polyethylene (“UHWMPE”) fibers, basalt fibers, natural fibers, the like and combinations thereof.

Similarly, each of the one or more other compounds 264 may be the same or different from the first compound 260 and/or the second compound 262. For example, each of the one or more other compounds 264 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

As illustrated in FIG. 2F, the method 200 may further include disposing 212 a final or last fiber material 226 in the mold cavity 232. As illustrated, the final or last fiber material 226 may be disposed 212 on or adjacent to an exposed surface of the one or more other layers 244 so as to define a last row or layer 246 in the mold cavity 232. The final fiber material 226 may be the same as or different from the first fiber material 220, the second fiber material 222, and/or the one or more other fiber materials 224. For example, the last fiber material 226 may be selected from carbon fibers, glass fibers, poly paraphenylene terephthalamide fibers (KEVLAR® fibers), ultra-high molecular weight polyethylene (“UHWMPE”) fibers, basalt fibers, natural fibers, the like and combinations thereof. The final fiber material 226 may be disposed using the same process used to dispose the first fiber material 220, the second fiber material 222, and/or the one or more other fiber materials 224.

As illustrated in FIG. 2G, the method 200 may further include disposing 214 a photosensitizer compound 266 in the mold cavity 232 so as to infuse or cover or coat the final fiber material 226. The photosensitizer compound 266 may be disposed 214 using the same process used to dispose the first compound 260, the second compound 262, and/or the one or more other compounds 264.

In certain variations, the final compound 266 includes a thermal initiator, a monomer, and a photosensitizer. In other variations, the final compound 266 includes a thermal initiator, a monomer, a cationic photoinitiator, and a photosensitizer. In each instance, the final compound 266 optionally includes a diluent. For example, the final compound 266 may include greater than or equal to about 0.1 mol % to less than or equal to about 5 mol % of the photosensitizer; greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The thermal initiator, monomer, and/or cationic photoinitiator of the final compound 226 may be the same or different from the thermal initiator, monomer, and/or cationic photoinitiator of the first compound 260, as well as the second compound 262 and/or the one or more other compounds 264. In certain variations, the photosensitizer may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

As illustrated in FIG. 2H, the method 200 may further include using an ultraviolet light source 270 (e.g., UV-LED) so as to initiated photopolymerization 216 of the photosensitizer of the final compound 266. The ultraviolet light source 270 may have a wavelength around about 365 nm. The ultraviolet light emitted from the ultraviolet light source 270 is unable to penetrate each of the plurality of layers 240, 242, 244, 246, but is able to initiated the photosensitizer, which may then transfer energy to the cationic photoinitiator, so as to being an exothermic reaction curing of the monomer (e.g., epoxy) so as to form the fiber-reinforced composite 290. The curing may be aided by the thermal initiator, which helps to keep the reaction progressing through the thickness and length of the plurality of layers 240, 242, 244, 246. The selection of thermally conducting fibers (e.g., the first fiber material 220, the second fiber material 222, the one or more other fiber materials 224, and/or the last fiber material 226), such as carbon fibers, may also help to propagate the thermal front within the plurality of layers 240, 242, 244, 246. In this manner, a total thickness of the fiber-reinforced composite 290 is not limited by the penetration depth of the ultraviolet light emitted from the ultraviolet light source 270

In various aspects, the ultraviolet light source 270 may be positioned at various points relative to the plurality of layers 240, 242, 244, 246. For example, a single light source 270 placed at the center of a square mold 230 may have a radially expanding cure front, while a single light source 270 placed near the end of the square mold may propagate along the length of the mold 230 as a linear front. In other examples, one or more light sources may be used to accelerate the curing process from different positions.

As illustrated in FIG. 2I, the ultraviolet light source 270 may be removed or turned off 218 after the start of frontal polymerization. In certain aspects, the ultraviolet light source 270 may be moved to another position relative to the mold 230. Even after the removal of the ultraviolet light source 270, as illustrated in FIG. 2J, polymerization continues until polymerization across the plurality of layers 240, 242, 244, 246 is complete and the fiber-reinforced composite 290 is formed. Though not illustrated, in certain variations, the method 200 includes removing the fiber-reinforced composite 290 from the mold 230.

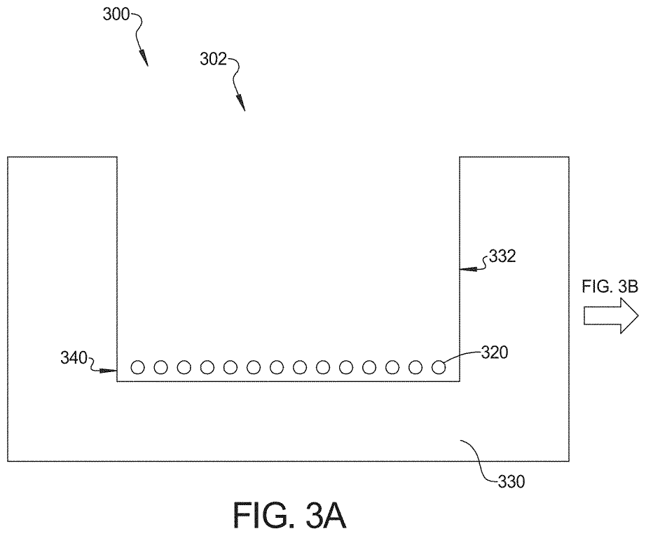

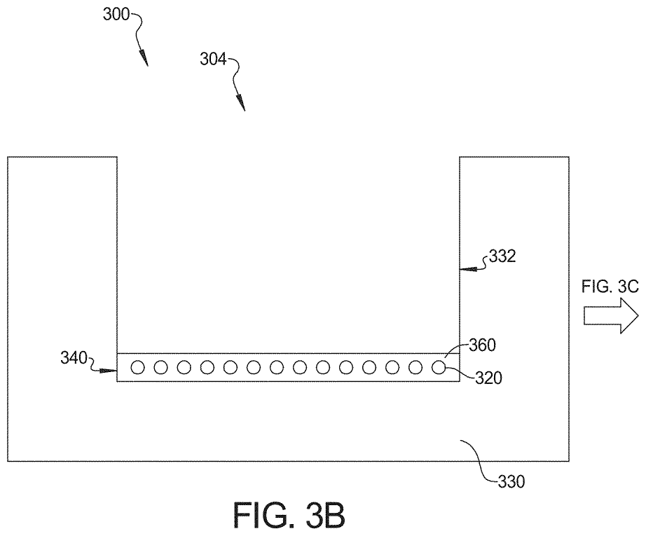

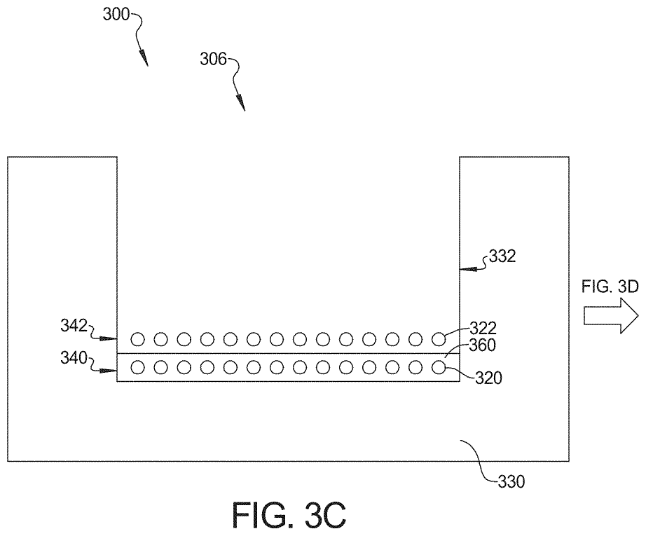

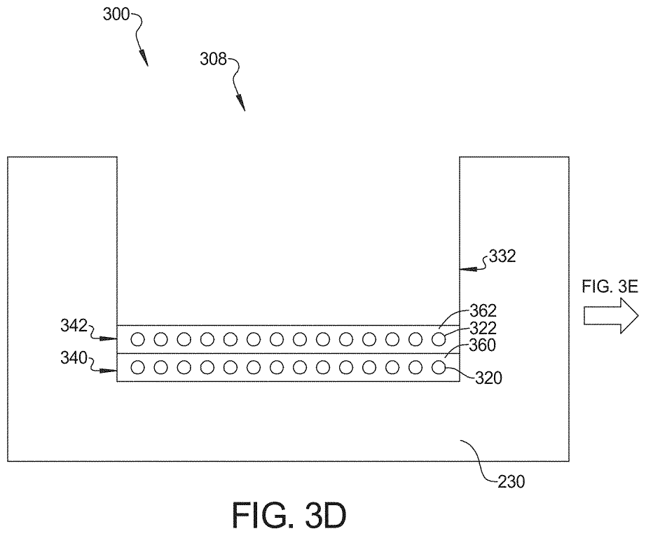

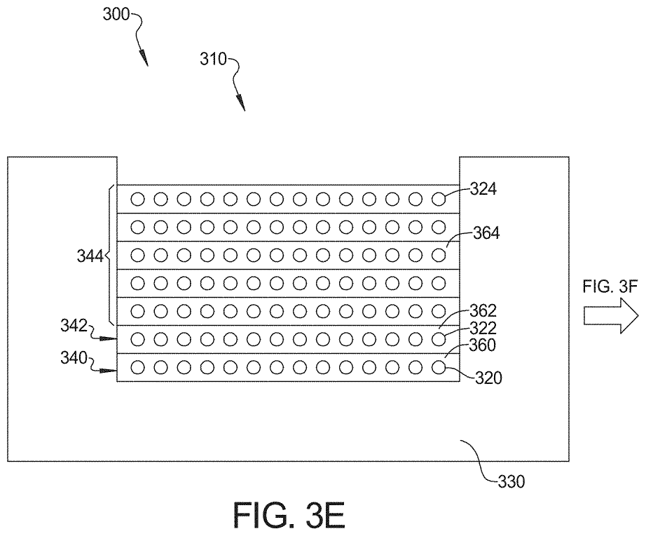

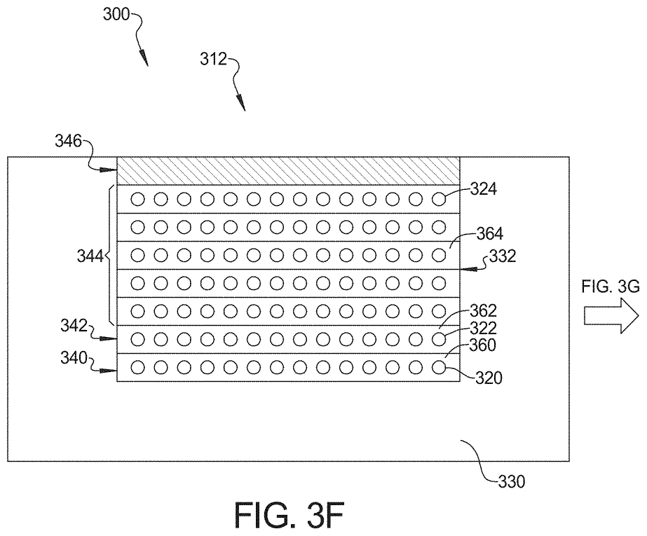

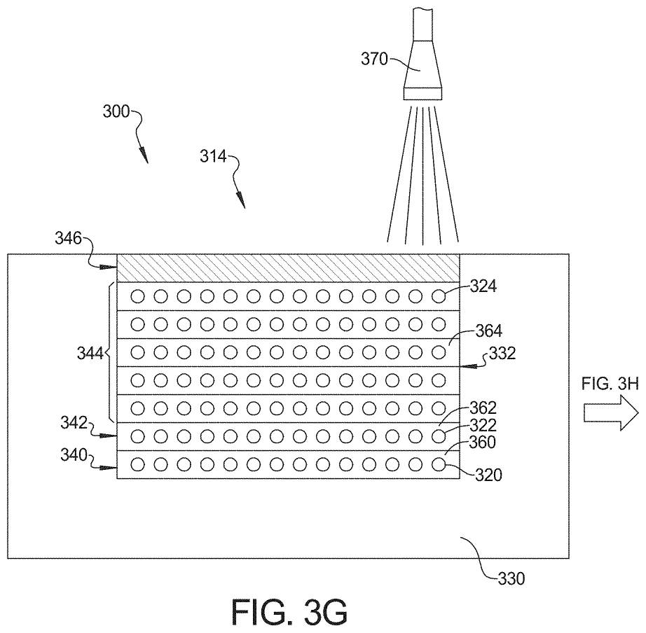

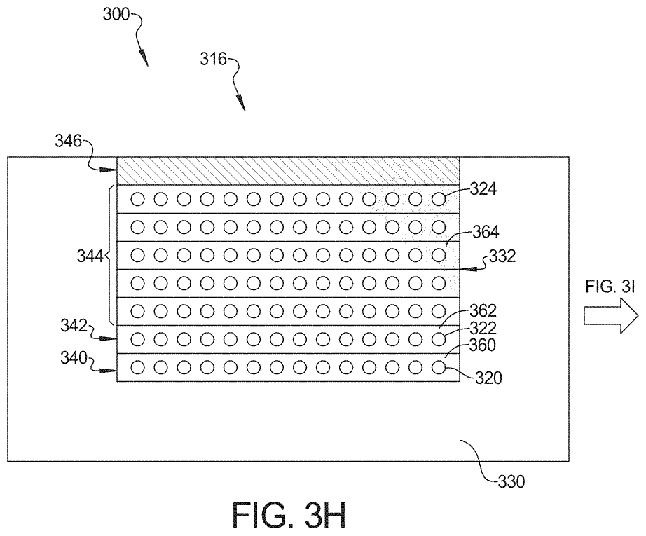

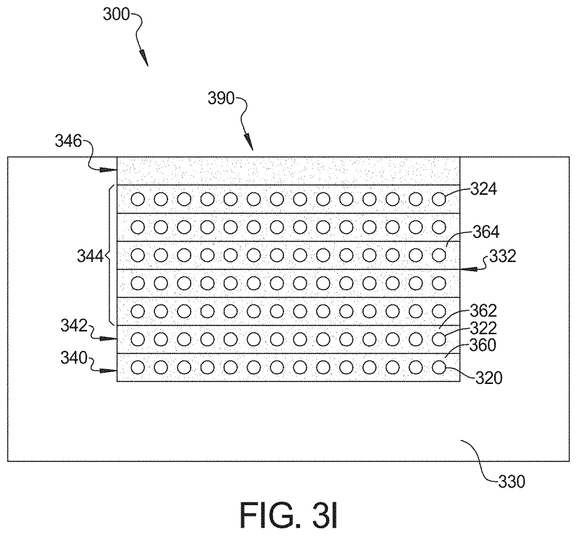

FIG. 3A-3I illustrate another example method for forming a fiber-reinforced composite 390. The method 300 may be a layer-by-layer process that includes a fiber free layer. For example, the method 300 may include sequentially forming one or more first rows or layers 340, 342, 344, where each of one or more first rows or layers 340, 342, 344 include a fiber material 320, 322, 324 and a coating compound 360, 362, 364. The method 300 may further include disposing a second row or layer 346 on or adjacent to the one or more first rows or layers 340, 342, 344. The second layer 326 includes a photosensitizer.

For example, as illustrated, at FIG. 3A, the method 300 includes disposing 302 a first fiber material 320 in a mold cavity 332. The first fiber material 320 defines a first row or layer 340. Though horizontal rows and layers 340 are illustrated, various other shapes and configurations would be recognized by the skilled artisan, including, for example only, vertical rows. Similarly, the skilled artisan will recognize that that the mold 330 and/or mold cavity 332 may have a variety of other shapes and configurations.

The first fiber material 320 includes one or more short or continuous fibers. The continuous fibers may be woven (e.g., twill weaved, 5 harness satin, 8 harness satin), non-crimp fabrics, or unidirectional, also including fibers, fiber tows, and fiber tapes. For example, the first fiber material 320 may each be selected from carbon fibers, glass fibers, polyparaphenylene terephthalamide fibers (KEVLAR® fibers), ultra-high molecular weight polyethylene (“UHWMPE”) fibers, basalt fibers, natural fibers, the like and combinations thereof.

As illustrated in FIG. 3B, the method 300 may further include disposing 304 a first compound 360 in the mold cavity 332 so as to infuse or cover or coat the first fiber material 320. In certain variations, the first compound 360 includes a thermal initiator and a monomer. In other variations, the first compound 360 includes a thermal initiator, a monomer, and a cationic photoinitiator. In each instance, the first compound 360 optionally includes a diluent. For example, the first compound 360 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

In certain variations, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In certain variations, the monomer includes one or more epoxy thermoset resins, such as diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE′ resin 827, and the like. In other variations, the monomer includes one or more open ring-opening polymerization monomers. In still over variations, the monomer includes non-cyclic monomers, such as vinyl ethers.

In each instance, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

The cationic photoinitiator may be suitable for frontal polymerization. For example, in certain variations, the cationic photoinitiator includes one or more photoacid generators (“PAGs”), such as those represented by the following formulas (including the respective trade names and businesses from which such compounds are commercially available, as well as a wavelength of maximum absorbance for UV-Visible Spectroscopy, designated as λₘₐₓ, where applicable):

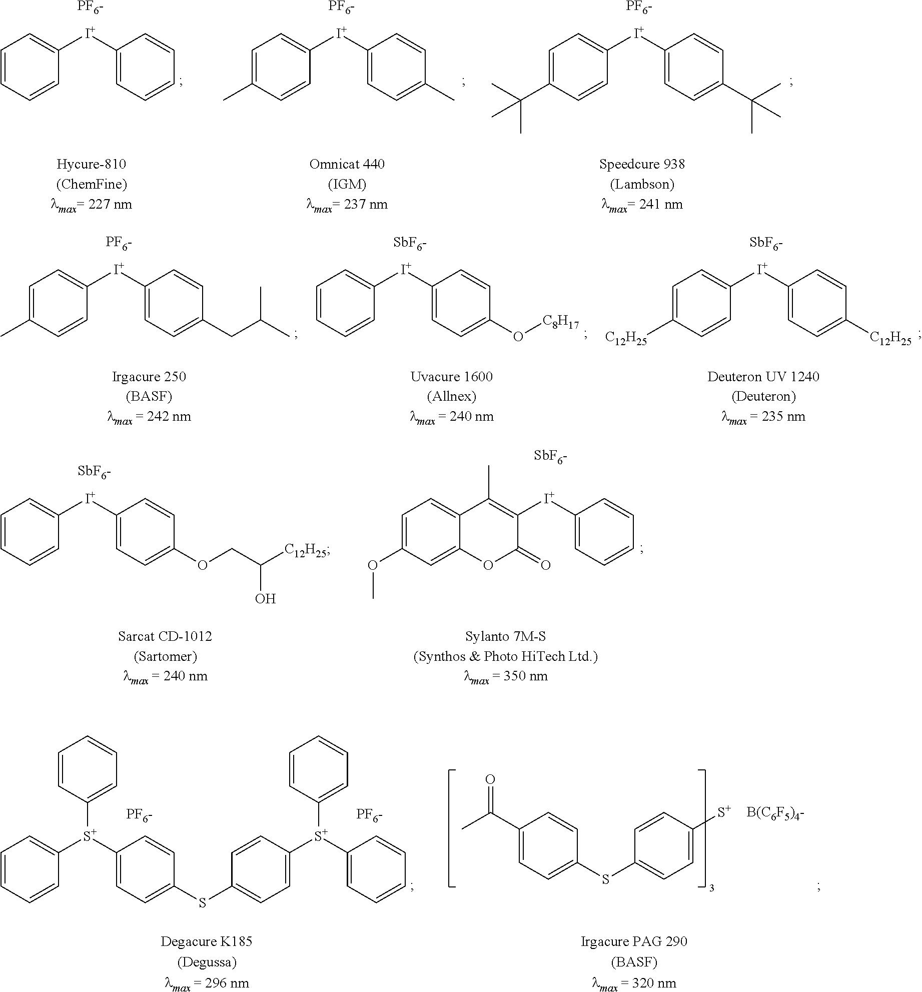

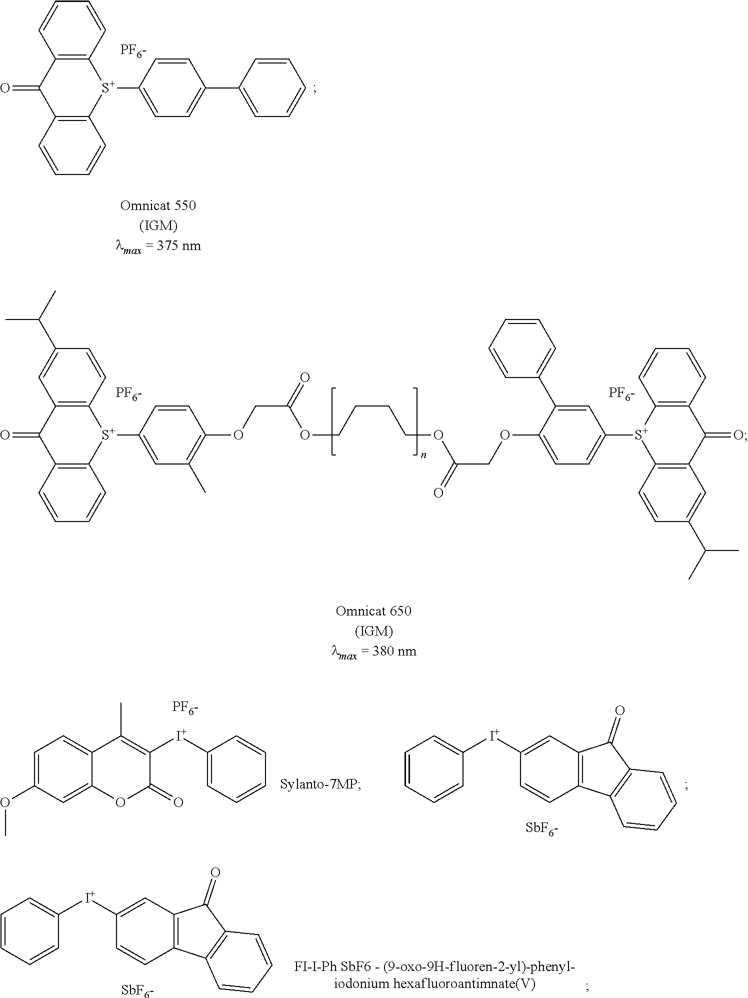

the like and combinations thereof.

In certain variations, the diluent includes polyfunctional glycidyl ethers (such as, HELOXY™ 107, HELOXY™ 48, HELOXY™ 68, and the like), monofunctional aliphatic glycidyl ethers (such as, HELOXY™ 166, HELOXY™ 61, and the like), monofunctional aromatic glycidyl ethers (such as HELOXY™ 62 and the like), 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), the like and combinations thereof.

As illustrated in FIG. 3C, the method 300 may further include disposing 306 a second fiber material 322 in the mold cavity 332. The second fiber material 322 defines a second row to layer 342. As illustrated, the second layer 342 may be disposed 306 on or adjacent to an exposed surface of the first row 340. The second fiber material 322 may be the same as or different from the first fiber material 320. For example, the second fiber material 322 may be selected from carbon fibers, glass fibers, poly praraphenylene terephthalamide fibers (e.g., KEVLAR® fibers), ultra-high molecular weight polyethylene (“UHWMPE”) fibers, basalt fibers, natural fibers, the like and combinations thereof.

As illustrated in FIG. 3D, the method 300 may further include disposing 308 a second compound 362 in the mold cavity 332 so as to infuse or cover or coat the second fiber material 320. The second compound 362 may be the same as or different from the first compound 360. For example, in certain variations, the second compound 362 includes a thermal initiator and a monomer. In other variations, the second compound 362 includes a thermal initiator, a monomer, and a cationic photoinitiator. In each instance, the second compound 362 optionally includes a diluent. Like the first compound 360, the second compound 362 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

As illustrated in FIG. 3E, the method 300 may further include disposing 310 one or more other rows or layers 344 in the mold cavity 332. For example, the method 300 may include subsequently disposing 310 one or more other fiber materials 324 and one or more other compounds 364 in the mold cavity 332, using method similar to those used to form the first layer 340 and/or the second layer 342. As illustrated, the method 300 may include disposing 310 five other layers 344 on or adjacent to an exposed surface of the second row 342.

Each of the one or more other fiber materials 324 may be the same or different from the first fiber material 320 and/or the second fiber material 322. For example, each of the one or more other fiber materials 324 may be independently selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

Similarly, each of the one or more other compounds 364 may be the same or different from the first compound 360 and/or the second compound 362. For example, each of the one or more other compounds 364 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

As illustrated in FIG. 3F, the method 300 may further include disposing 312 a photosensitizer layer 346 in the mold cavity 332. As illustrated, the photosensitizer layer 346 may be disposed 312 on or adjacent to an exposed surface of the one or more other layers 344 so as to define a last row or layer 346 in the mold cavity 332. The photosensitizer layer 346 may be disposed 312 using a spray coating process. The photosensitizer layer 346 may have a thickness different from the other layers 340, 342, 344. For example, the photosensitizer layer 346 may have a thickness greater than or equal to about 0.01 mm to less than or equal to about 0.5 mm. The first layer 340 and/or the second layer 342 and/or the one or more other rows or layers 344 may each have a cured thickness of greater than or equal to about 30 μm to less than or equal to about 500 μm.

In certain variations, the photosensitizer layer 346 includes a thermal initiator, a monomer, and a photosensitizer. In other variations, the photosensitizer layer 346 includes a thermal initiator, a monomer, a cationic photoinitiator, and a photosensitizer. In each instance, the photosensitizer layer 346 optionally includes a diluent. For example, the photosensitizer layer 346 may include greater than or equal to about 0.1 mol % to less than or equal to about 5 mol % of the photosensitizer; greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The thermal initiator, monomer, and/or cationic photoinitiator of the photosensitizer layer 346 may be the same or different from the thermal initiator, monomer, and/or cationic photoinitiator of the first compound 260, as well as the second compound 262 and/or the one or more other compounds 264. In certain variations, the photosensitizer may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

As illustrated in FIG. 3G, the method 300 may further include using an ultraviolet light source 370 (e.g., UV-LED) so as to initiated photopolymerization 314 of the photosensitizer of the final layer 346. As illustrated in FIG. 3H, the ultraviolet light source 370 may be removed or turned off 316 after the start of frontal polymerization. Even after the removal of the ultraviolet light source 370, as illustrated in FIG. 3I, polymerization continues until polymerization across the plurality of layers 340, 342, 344, 346 is complete and the fiber-reinforced composite 390 is formed. Though not illustrated, in certain variations, the method 300 includes removing the fiber-reinforced composite 390 from the mold 330.

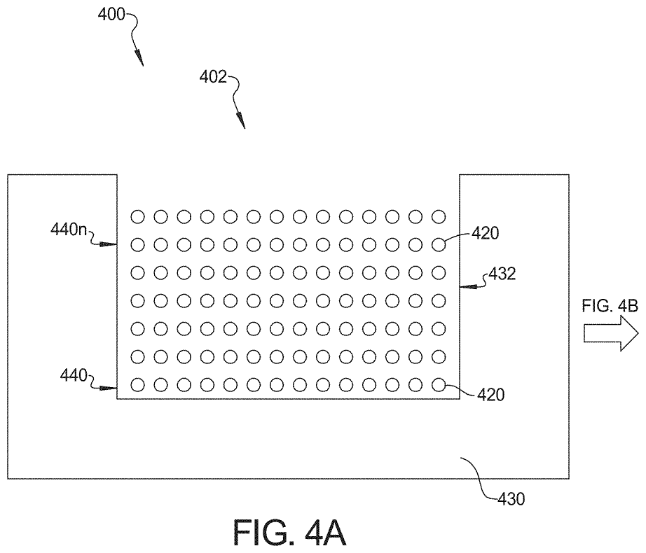

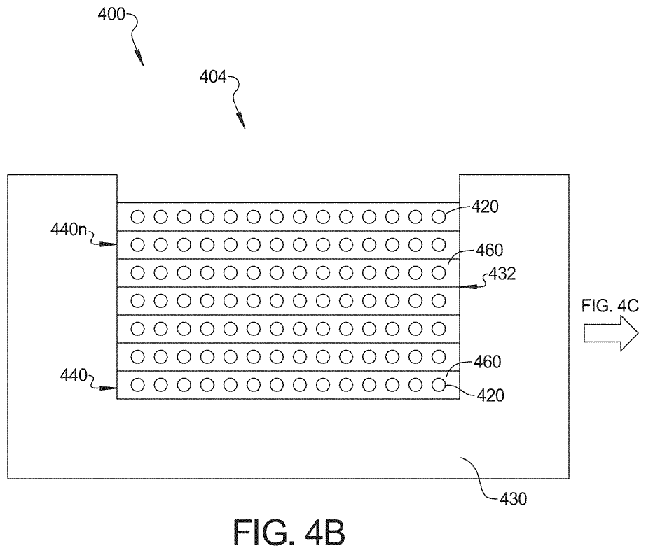

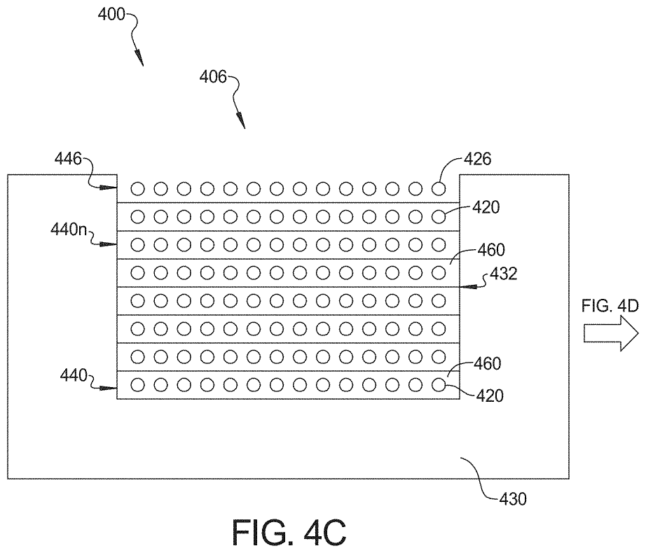

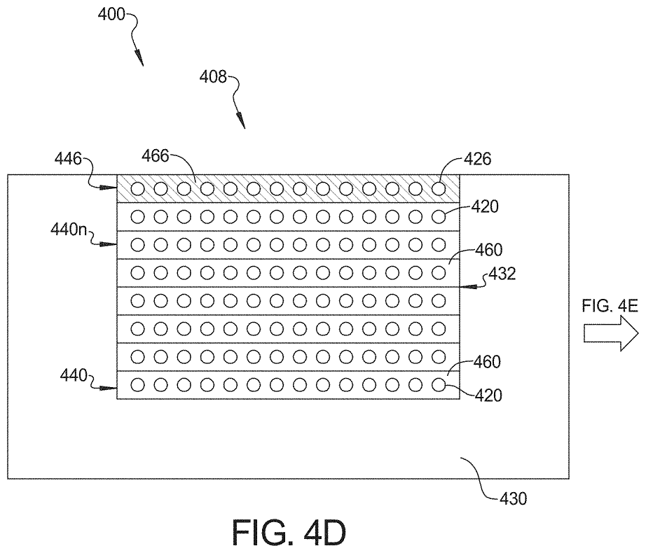

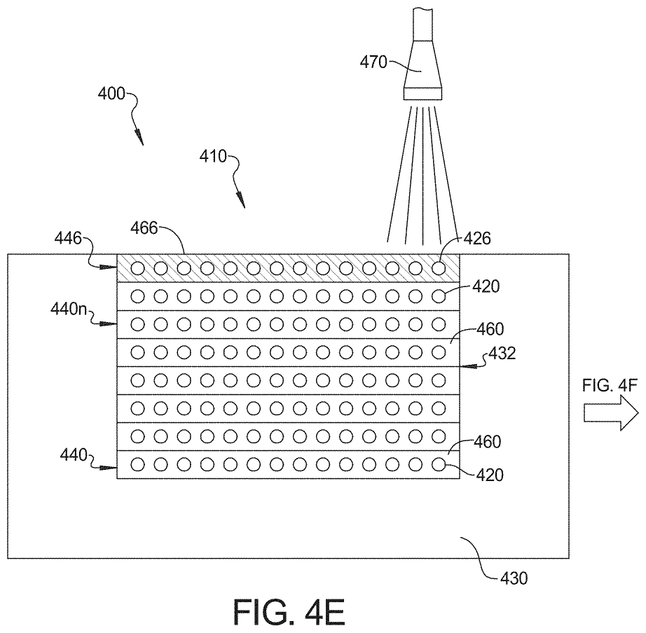

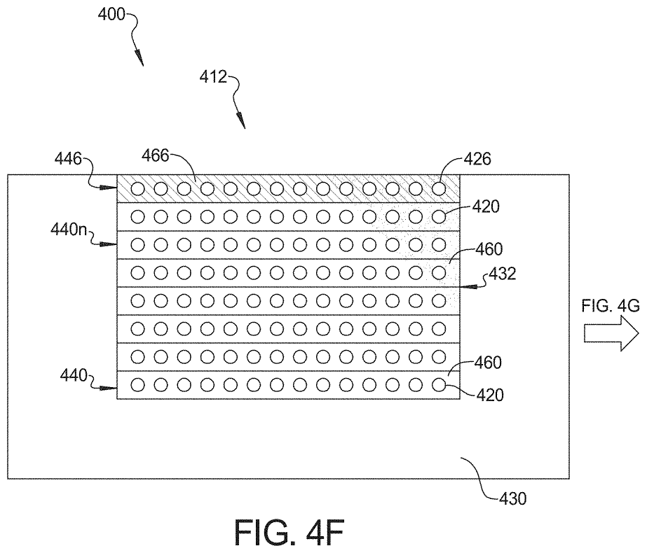

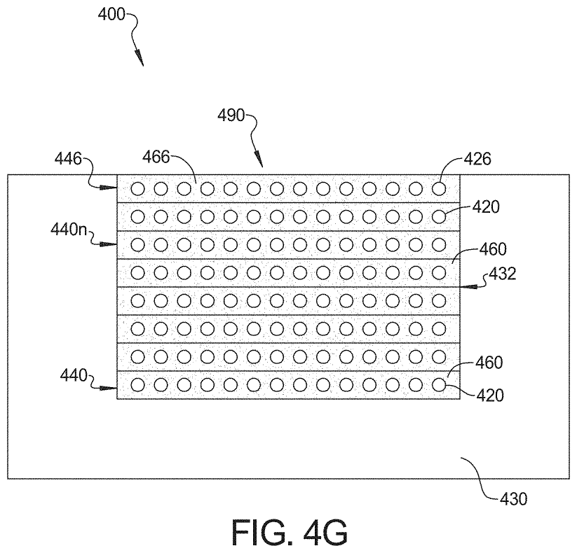

FIGS. 4A-4G illustrate another example method 400 for forming a fiber-reinforced composite 490. The method 400 may be a two-step infusion process that includes disposing one or more fiber materials 420, 426 and one or more coating compounds 460, 466.

For example, as illustrated at FIG. 4A, the method 400 may include disposing 402 a first fiber material 420 in a mold cavity 432. The first fiber material 420 may be disposed 402 so as to form one or more rows or layers 440. For example, as illustrated, the first fiber material 420 may be disposed to form seven layers 440. Though horizontal layers 440 are illustrated here, various other shapes and configurations would be recognized by the skilled artisan, including, for example only, vertical rows. Similarly, the skilled artisan will recognize that the mold 430 and/or mold cavity 432 may have a variety of other shapes and configurations.

The first fiber material 420 includes one or more short or continuous fibers. The continuous fibers may be woven (e.g., twill weaved, 5 harness satin, 8 harness satin), non-crimp fabrics, or unidirectional, also including fibers, fiber tows, and fiber tapes. For example, the first fiber material 420 may each be selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

As illustrated at FIG. 4B, the method 400 may further include disposing 404 a first compound 460 in the mold cavity 432 so as to infuse or cover or coat each of the first fiber materials 420 of the one or more layers 440.

In certain variations, the first compound 460 includes a thermal initiator and a monomer. In other variations, the first compound 460 includes a thermal initiator, a monomer, and a cationic photoinitiator. In each instance, the first compound 460 optionally includes a diluent. For example, the first compound 460 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

In certain variations, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In certain variations, the monomer includes one or more epoxy thermoset resins, such as diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, and the like. In other variations, the monomer includes one or more open ring-opening polymerization monomers. In still over variations, the monomer includes non-cyclic monomers, such as vinyl ethers.

In each instance, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

The cationic photoinitiator may be suitable for frontal polymerization. For example, in certain variations, the cationic photoinitiator includes one or more photoacid generators (“PAGs”), such as those represented by the following formulas (including the respective trade names and businesses from which such compounds are commercially available, as well as a wavelength of maximum absorbance for UV-Visible Spectroscopy, designated as λₘₐₓ, where applicable):

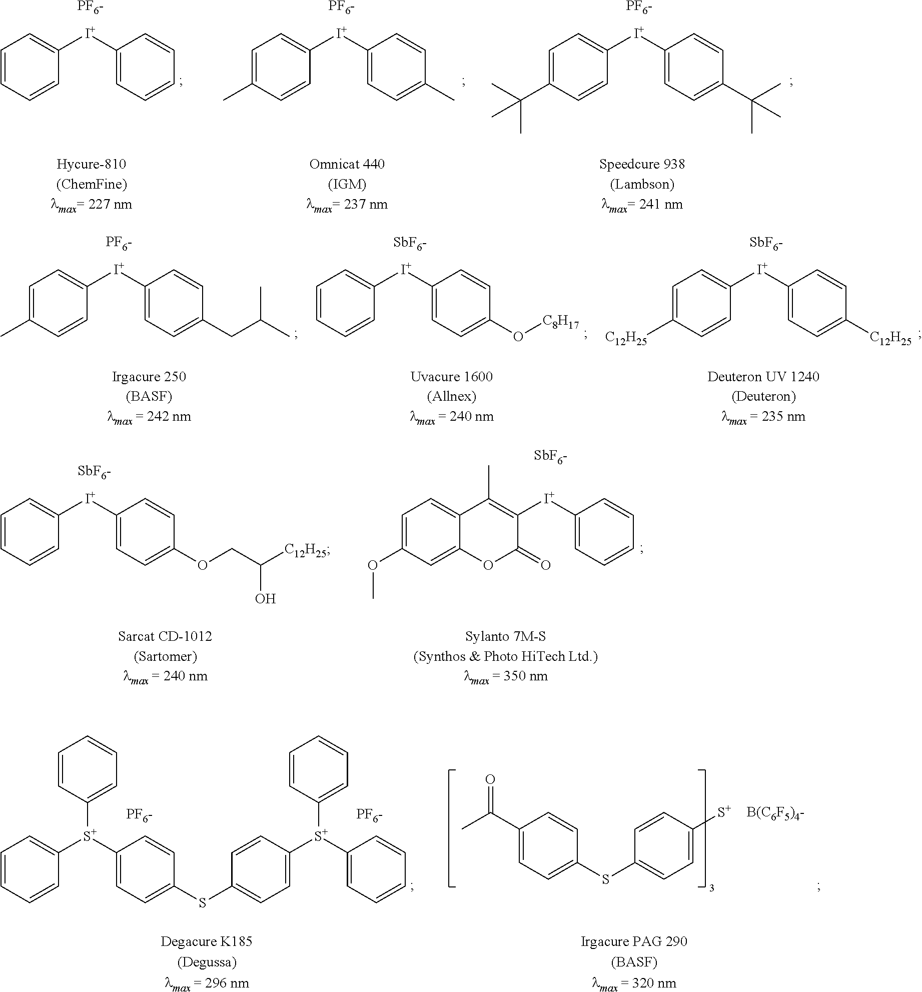

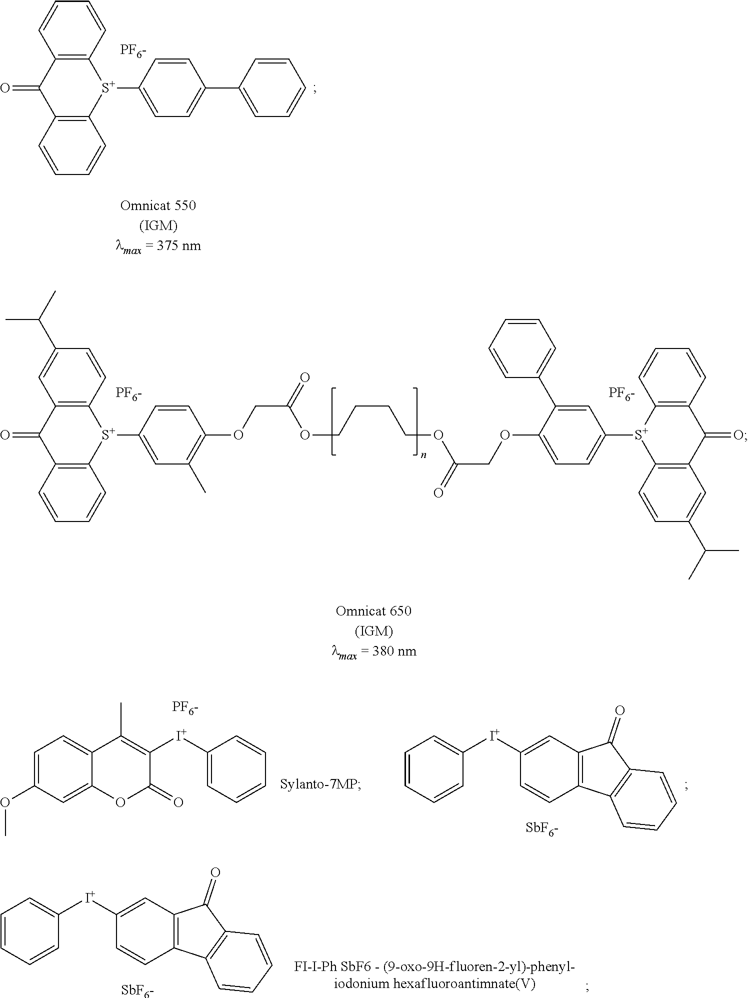

the like and combinations thereof.

In certain variations, the diluent includes polyfunctional glycidyl ethers (such as, HELOXY™ 107, HELOXY™ 48, HELOXY™ 68, and the like), monofunctional aliphatic glycidyl ethers (such as, HELOXY™ 166, HELOXY™ 61, and the like), monofunctional aromatic glycidyl ethers (such as HELOXY™ 62 and the like), 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), the like and combinations thereof.

As illustrated in FIG. 4C, the method 400 may further include disposing 406 a second fiber material 426 in the mold cavity 432. As illustrated, the second fiber material 426 may be disposed 412 on or adjacent to an exposed surface of the one or more layers 440 so as to define a last row or layer 446 in the mold cavity 432. The second fiber material 426 may be the same as or different from the first fiber material 420. For example, the second fiber material 426 may be selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

As illustrated in FIG. 4D, the method 400 may further include disposing 408 a second compound 466 in the mold cavity 432 so as to infuse or cover or coat the second fiber material 426.

In certain variations, the second compound 466 includes a thermal initiator, a monomer, and a photosensitizer. In other variations, the second compound 466 includes a thermal initiator, a monomer, a cationic photoinitiator, and a photosensitizer. In each instance, the second compound 466 optionally includes a diluent. For example, the second compound 466 may include greater than or equal to about 0.1 mol % to less than or equal to about 5 mol % of the photosensitizer; greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The thermal initiator, monomer, and/or cationic photoinitiator of the second compound 426 may be the same or different from the thermal initiator, monomer, and/or cationic photoinitiator of the first compound 460. In certain variations, the photosensitizer may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

As illustrated in FIG. 4E, the method 400 may further include using an ultraviolet light source 470 (e.g., UV-LED) so as to initiated photopolymerization 410 of the photosensitizer of the second compound 466. As illustrated in FIG. 4F, the ultraviolet light source 470 may be removed or turned off 412 after the start of frontal polymerization. Even after the removal of the ultraviolet light source 470, as illustrated in FIG. 4G, polymerization continues until polymerization across the plurality of layers 440, 446 is complete and the fiber-reinforced composite 490 is formed. Though not illustrated, in certain variations, the method 400 includes removing the fiber-reinforced composite 490 from the mold 430.

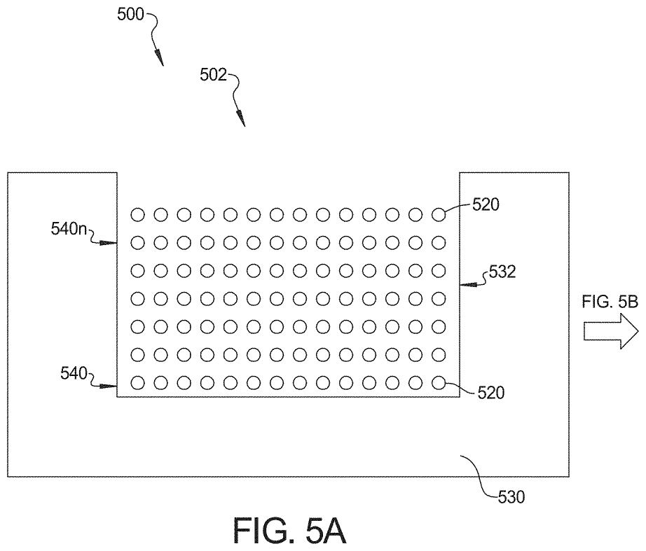

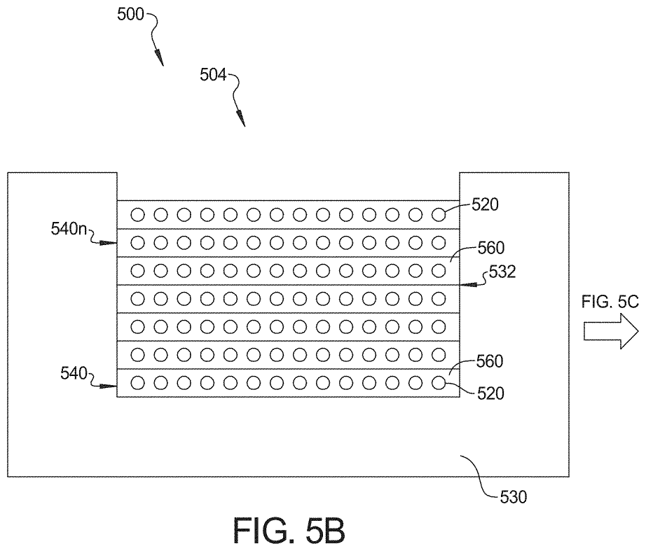

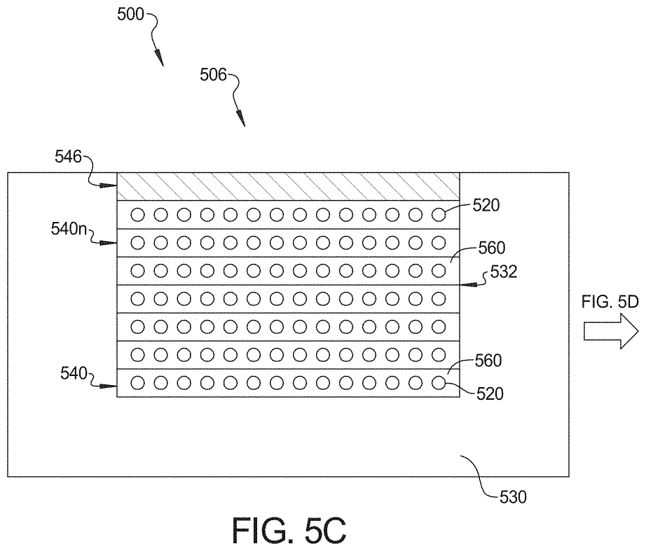

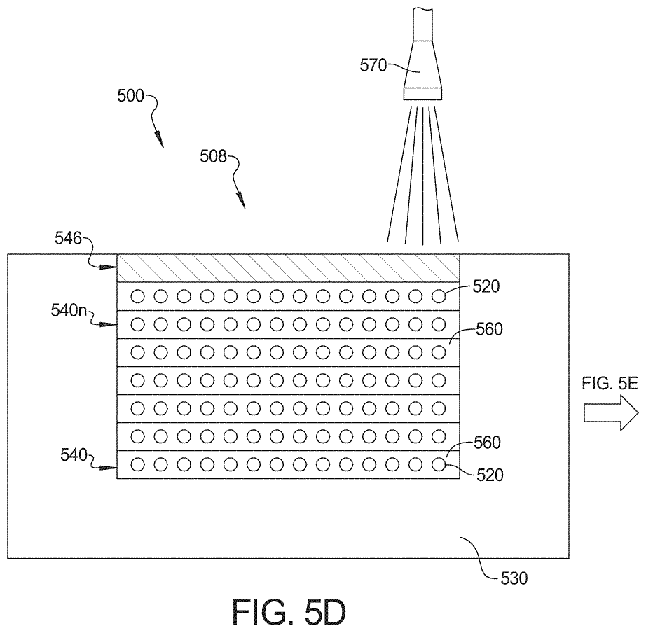

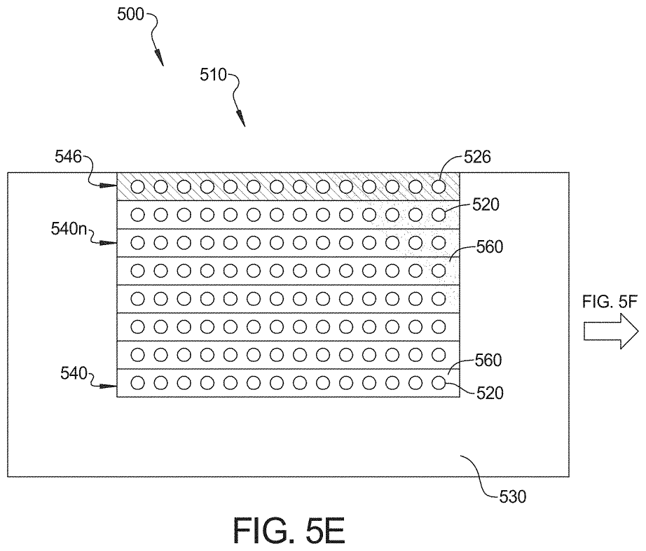

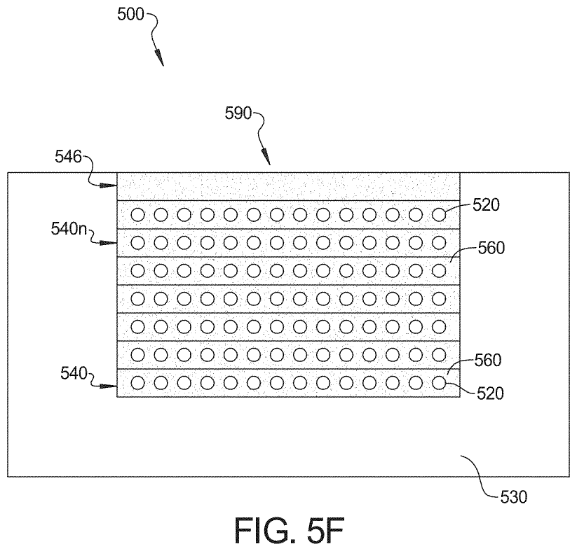

FIGS. 5A-5F illustrate another example method for forming a fiber-reinforced composite 590. The method 500 may be a two-step infusion process that includes disposing one or more first layers including one or more fiber materials 520 and one or more coating compounds 560 and a second layer 526 (e.g., fiber free layer) including a second compound 566.

For example, as illustrated at FIG. 5A, the method 500 may include disposing 502 a first fiber material 520 in a mold cavity 532. The first fiber material 520 may be disposed 502 so as to form one or more rows or layers 540. For example, as illustrated, the first fiber material 520 may be disposed to form seven layers 540. Though horizontal layers 540 are illustrated here, various other shapes and configurations would be recognized by the skilled artisan, including, for example only, vertical rows. Similarly, the skilled artisan will recognize that the mold 530 and/or mold cavity 532 may have a variety of other shapes and configurations.

The first fiber material 520 includes one or more short or continuous fibers. The continuous fibers may be woven (e.g., twill weaved, 5 harness satin, 8 harness satin), non-crimp fabrics, or unidirectional, also including fibers, fiber tows, and fiber tapes. For example, the first fiber material 520 may each be selected from carbon fibers, glass fibers, poly paraphenylene terephthalamide fibers (e.g., KEVLAR® fibers), ultra-high molecular weight polyethylene (“UHWMPE”) fibers, basalt fibers, natural fibers, the like and combinations thereof.

As illustrated at FIG. 5B, the method 500 may further include disposing 504 a first compound 560 in the mold cavity 532 so as to infuse or cover or coat each of the first fiber materials 520 of the one or more layers 540.

In certain variations, the first compound 560 includes a thermal initiator and a monomer. In other variations, the first compound 560 includes a thermal initiator, a monomer, and a cationic photoinitiator. In each instance, the first compound 560 optionally includes a diluent. For example, the first compound 560 may include greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

In certain variations, the thermal initiator may be selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof.

In certain variations, the monomer includes one or more epoxy thermoset resins, such as diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE′ resin 827, and the like. In other variations, the monomer includes one or more open ring-opening polymerization monomers. In still over variations, the monomer includes non-cyclic monomers, such as vinyl ethers.

In each instance, the monomer may be selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof.

The cationic photoinitiator may be suitable for frontal polymerization. For example, in certain variations, the cationic photoinitiator includes one or more photoacid generators (“PAGs”), s such as those represented by the following formulas (including the respective trade names and businesses from which such compounds are commercially available, as well as a wavelength of maximum absorbance for UV-Visible Spectroscopy, designated as λₘₐₓ, where applicable):

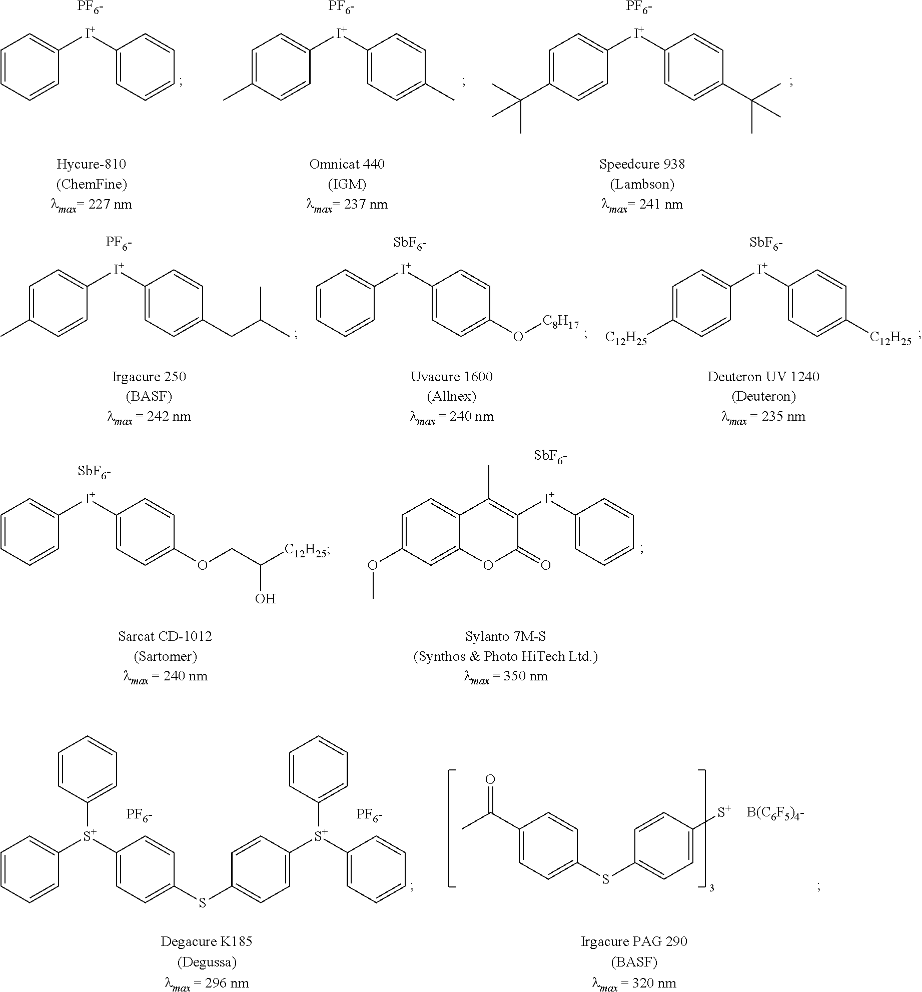

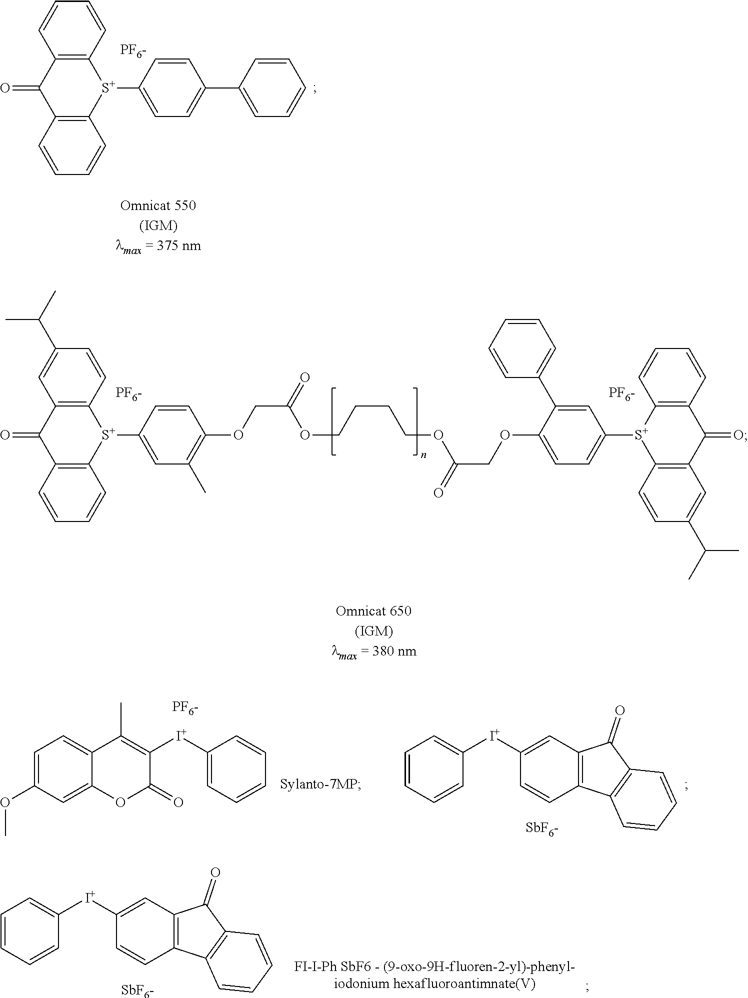

the like and combinations thereof.

In certain variations, the diluent includes polyfunctional glycidyl ethers (such as, HELOXY™ 107, HELOXY™ 48, HELOXY™ 68, and the like), monofunctional aliphatic glycidyl ethers (such as, HELOXY™ 166, HELOXY™ 61, and the like), monofunctional aromatic glycidyl ethers (such as HELOXY™ 62 and the like), 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), the like and combinations thereof.

As illustrated in FIG. 5C, the method 500 may further include disposing 506 a photosensitizer layer 546 in the mold cavity 532. As illustrated, the photosensitizer layer 546 may be disposed 512 on or adjacent to an exposed surface of the one or more other layers 540 so as to define a last row or layer 546 in the mold cavity 532. The photosensitizer layer 546 may be disposed 506 using a spray coating process. The photosensitizer layer 546 may have a thickness different from the other layers 540. For example, the photosensitizer layer 546 may have a thickness greater than or equal to about 0.01 mm to less than or equal to about 0.5 mm.

In certain variations, the photosensitizer layer 546 includes a thermal initiator, a monomer, and a photosensitizer. In other variations, the photosensitizer layer 546 includes a thermal initiator, a monomer, a cationic photoinitiator, and a photosensitizer. In each instance, the photosensitizer layer 546 optionally includes a diluent. For example, the photosensitizer layer 546 may include greater than or equal to about 0.1 mol % to less than or equal to about 5 mol % of the photosensitizer; greater than or equal to about 0.1 mol % to less than or equal to about 10 mol % of the thermal initiator; greater than or equal to about 20 mol % to less than or equal to about 99 mol % of the monomer; greater than or equal to about 0 mol % to less than or equal to about 10 mol % of the cationic photoinitiator; and greater than or equal to about 0 mol % to less than or equal to about 70 mol % of the optional diluent.

The thermal initiator, monomer, and/or cationic photoinitiator of the photosensitizer layer 546 may be the same or different from the thermal initiator, monomer, and/or cationic photoinitiator of the first compound 560. In certain variations, the photosensitizer may be selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

As illustrated in FIG. 4D, the method 500 may further include using an ultraviolet light source 570 (e.g., UV-LED) so as to initiated photopolymerization 508 of the photosensitizer of the final layer 546. As illustrated in FIG. 4E, the ultraviolet light source 570 may be removed or turned off 510 after the start of frontal polymerization. Even after the removal of the ultraviolet light source 570, as illustrated in FIG. 5F, polymerization continues until polymerization across the plurality of layers 540, 546 is complete and the fiber-reinforced composite 590 is formed. Though not illustrated, in certain variations, the method 500 includes removing the fiber-reinforced composite 590 from the mold 530.

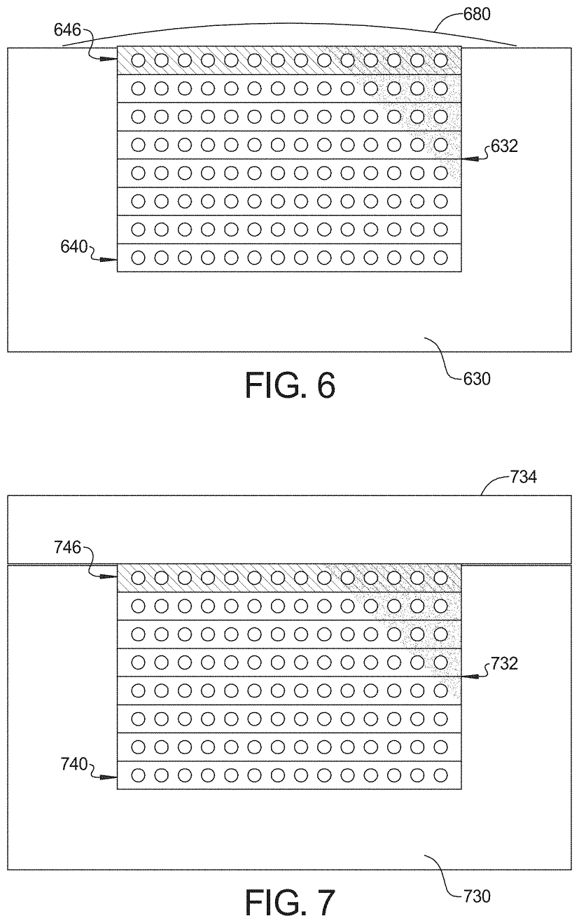

One or more of the above methods (e.g., method 200, method 300, method 400, method 500) may include using one or more other manufacturing processes. For example, as illustrated in FIG. 6, each of the methods may further include disposing a low thermal conductivity film 680 across a mold 630 so as to encase the one or more composite layers 640, which includes at least one layer 646 having a photosensitizer. The low thermal conductivity film 680 may be used to apply vacuum pressure to the one or more composite layers 640, 646 in a manner similar to a vacuum bag process and/or autoclave process. In certain instances, adding pressure to the one or more composite layers 640, 646 helps to consolidate the final composite (i.e., fiber-reinforced composite). For example, adding pressure may help to reduce or eliminate the porosity of the final composite (i.e., fiber-reinforced composite).

Further, in other instances, such as illustrated in FIG. 7, each of the methods may further include disposing a mold cover or cap 734 across a mold 730 so as to encase the one or more composite layers 740, which includes at least one layer 746 having a photosensitizer. The mold cover 734 may be used to apply pressure to the one or more composite layers 740, 746 and/or retain heat within the mold 730 such that the polymerization process occurs faster.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a fiber-reinforced composite, the method comprising:
disposing one or more layers in a mold cavity, the one or more layers each comprising a fiber material and a first compound;
disposing a second compound in the mold cavity, the second compound comprising a photosensitizer material;
initiating photopolymerization of the photosensitizer using an ultraviolet light source;
removing ultraviolet light source; and
completing polymerization of the one or more layers so as to form the fiber-reinforced composite.

2. The method of claim 1, wherein disposing the one or more layers comprises:
disposing the fiber material in the mold cavity; and
infusing the fiber material with the first compound.

3. The method of claim 1, wherein the fiber material comprises a first fiber material and a second fiber material and the first compound comprises a first composition and a second composition, and wherein disposing the one or more layers comprises:
disposing the first fiber material in the mold cavity;
infusing the first fiber material with the first composition;
disposing the second fiber material in the mold cavity; and
infusing the second fiber material with the second composition, wherein the first and second fiber materials are the same or different and the first and second compositions are the same or different.

4. The method of claim 1, wherein the fiber material is selected from carbon fibers, glass fibers, poly praraphenylene terephthalamide fibers, ultra-high molecular weight polyethylene (“UHWMPE”) fibers, basalt fibers, natural fibers, and combinations thereof.

5. The method of claim 1, wherein the first compound comprises:
greater than or equal to about 0.1 mol % to less than or equal to about 10 mol % of a thermal initiator;
greater than or equal to about 20 mol % to less than or equal to about 99 mol % of a monomer;
greater than or equal to about 0 mol % to less than or equal to about 10 mol % of a cationic photoinitiator; and
greater than or equal to about 0 mol % to less than or equal to about 70 mol % of a diluent.

6. The method of claim 5, wherein the thermal initiator is selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof;
the monomer is selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE™ resin 827, vinyl ethers, and combinations thereof;
the cationic photoinitiator is selected from the group consisting of: 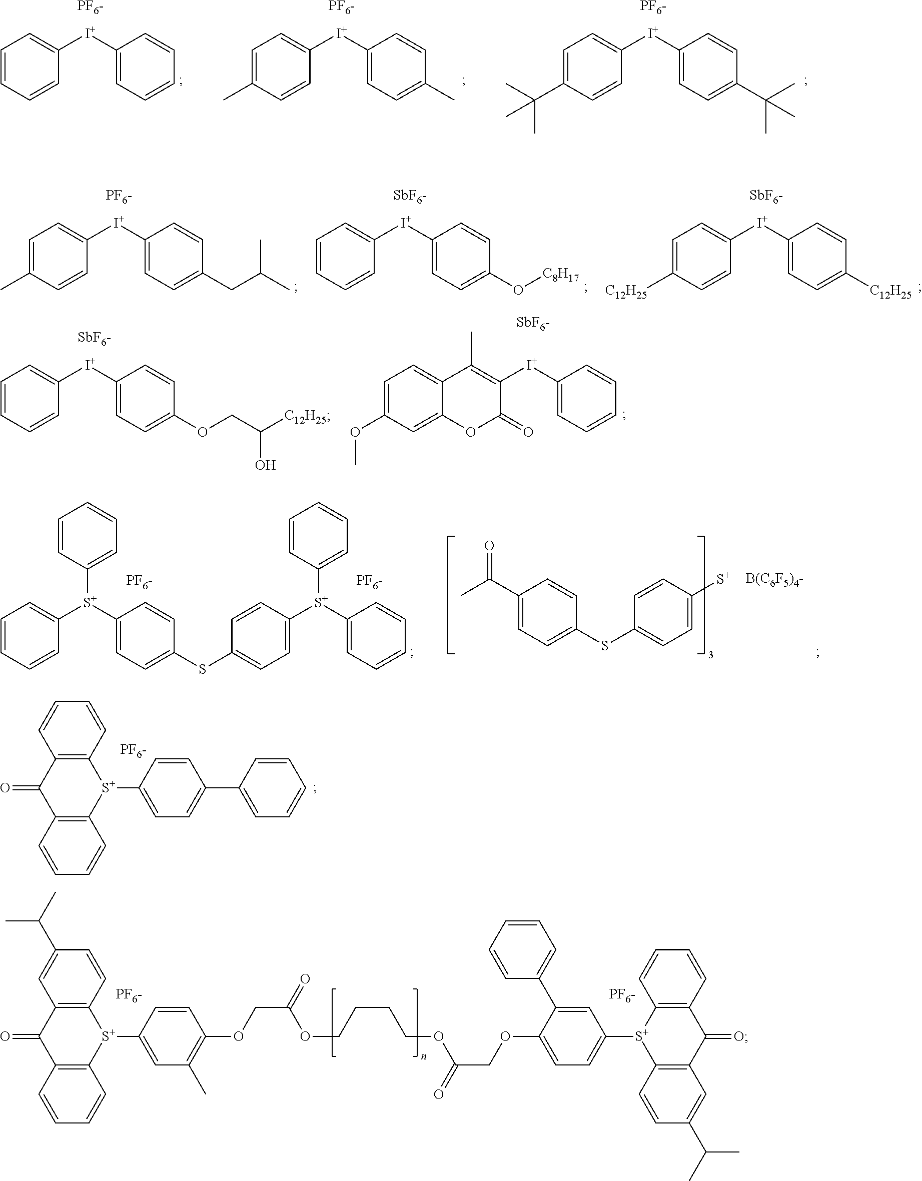 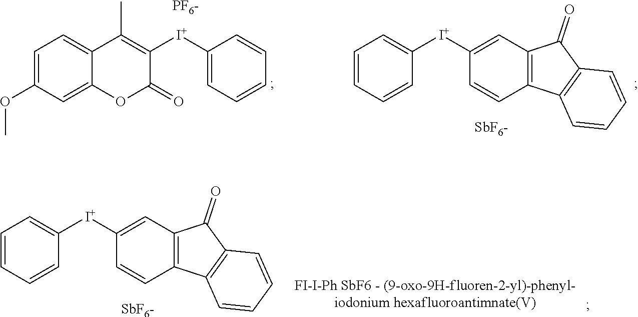
and combinations thereof; and
the diluent is selected from the group consisting of: polyfunctional glycidyl ethers, monofunctional aliphatic glycidyl ethers, monofunctional aromatic glycidyl ethers, 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), and combinations thereof.

7. The method of claim 1, wherein the fiber material is a first fiber material and the method further comprises:
disposing a second fiber material in the mold cavity on or adjacent to the one or more layers.

8. The method of claim 7, wherein disposing the second compound comprises infusing the second fiber material with the second compound.

9. The method of claim 1, wherein the second compound comprises: greater than or equal to about 0.1 mol % to less than or equal to about 5 mol % of a photosensitizer material.

10. The method of claim 9, wherein the photosensitizer material is selected from the group consisting of: anthracene, perylene, benzophenone, 9,10-diethoxyanthracene, 2,2-dimethoxy-1,2-diphenylethanone, 2-isopropylthioxanthone (ITX), and combinations thereof.

11. The method of claim 9, wherein the second compound further comprises:
greater than or equal to about 0.1 mol % to less than or equal to about 10 mol % of a thermal initiator;
greater than or equal to about 20 mol % to less than or equal to about 99 mol % of a monomer;
greater than or equal to about 0 mol % to less than or equal to about 10 mol % of a cationic photoinitiator; and
greater than or equal to about 0 mol % to less than or equal to about 70 mol % of an optional diluent.

12. The method of claim 11, wherein the thermal initiator is selected from the group consisting of: 1,1,2,2-tetraphenyl-1,2-ethanediol (TPED), benzopinacol bis(trimethylsilyl ether) (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN), and combinations thereof;
the monomer is selected from the group consisting of: diglycidyl ether bisphenol-A epoxy resin (DGEBA), diglycidyl ether bisphenol-F epoxy resin (DGEBF), 1,4-bis(glycidyloxy)benzene (CHDGE), 1,6-hexanediol diglycidyl ether (HDDGE), neopentyl glycol diglycidyl ether (NPDGE), 3,4-epoxycyclohexylmethyl 3,4-epoxycyclohexanecarboxylate (CE), resorcinyl diglycidyl ether 1,3-bis(2,3-spoxypropoxy)ben), 1,4-butanediol diglycidyl ether, EPIKOTE′ resin 827, vinyl ethers, and combinations thereof;
the cationic photoinitiator is selected from the group consisting of: 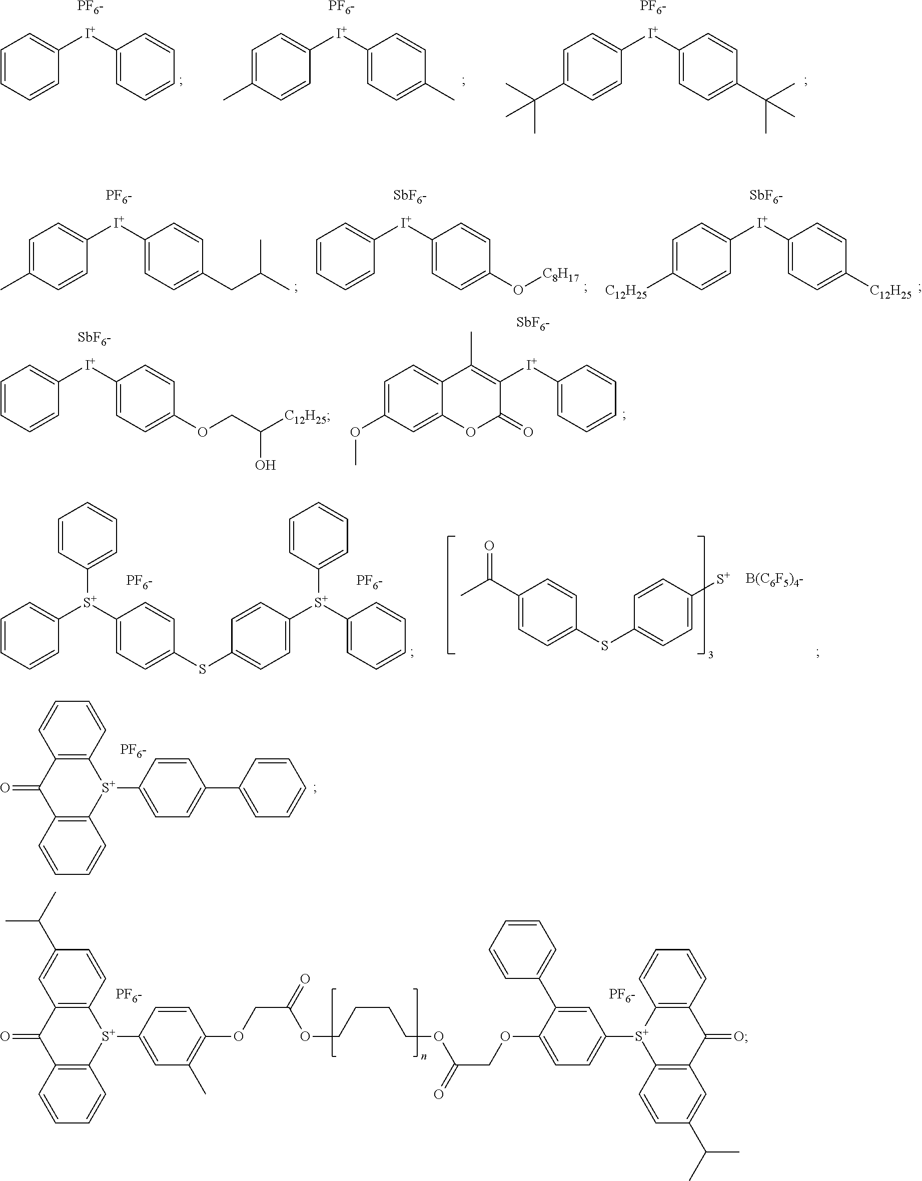 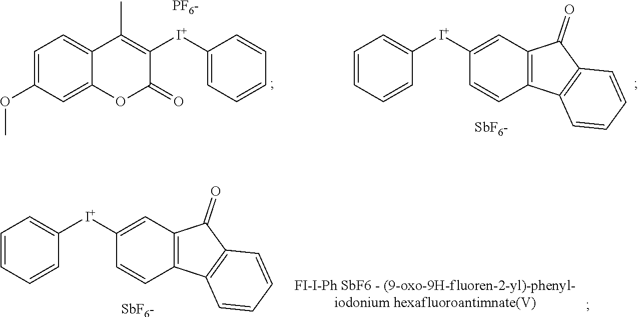
and combinations thereof; and
the diluent is selected from the group consisting of: polyfunctional glycidyl ethers, monofunctional aliphatic glycidyl ethers, monofunctional aromatic glycidyl ethers, 3-ethyl-3-oxetanemethanol (EOM), 1,4-bis(glycidyloxy)benzene (CHDGE), 1,6-hexanediol diglycidyl ether (HDDGE), neopentyl glycol diglycidyl ether (NPDGE), and combinations thereof.

13. The method of claim 1, wherein the method further comprises:
removing the fiber-reinforced composite from the mold cavity.

14. A method for forming a fiber-reinforced composite, the method comprising:
disposing a second compound comprising a photosensitizer material in a mold cavity, wherein the mold cavity comprises one or more layers and each of the or more layers comprises a fiber material and a first compound;
initiating photopolymerization of the sensitizer using an ultraviolet light source;
removing ultraviolet light source; and
completing polymerization of the one or more layers so as to form the fiber-reinforced composite.

15. The method of claim 14, wherein the fiber material is a first fiber material and the method further comprises:
disposing a second fiber material in the mold cavity on or adjacent to the one or more layers, and disposing the second compound comprises infusing the second fiber material with the second compound.

16. The method of claim 14, wherein the method further comprises:
disposing the one or more layers in the mold cavity and disposing the one or more layers comprises:
disposing the fiber material in the mold cavity; and
infusing the fiber material with the first compound.

17. The method of claim 14, wherein the fiber material comprises a first fiber material and a second fiber material and the first compound comprises a first composition and a second composition, and wherein the method further comprises:
disposing the one or more layers in the mold cavity and disposing the one or more layers comprises:
disposing the first fiber material in the mold cavity;
infusing the first fiber material with the first composition;
disposing the second fiber material in the mold cavity; and
infusing the second fiber material with the second composition, wherein the first and second fiber materials are the same or different and the first and second compositions are the same or different.

18. The method of claim 14, wherein the second compound comprises: greater than or equal to about 0.1 mol % to less than or equal to about 5 mol % of a photosensitizer material;
greater than or equal to about 0.1 mol % to less than or equal to about 10 mol % of a thermal initiator;
greater than or equal to about 20 mol % to less than or equal to about 99 mol % of a monomer;
greater than or equal to about 0 mol % to less than or equal to about 10 mol % of a cationic photoinitiator; and
greater than or equal to about 0 mol % to less than or equal to about 70 mol % of an optional diluent.

19. The method of claim 14, wherein the first compound comprises:
greater than or equal to about 0.1 mol % to less than or equal to about 10 mol % of a thermal initiator;
greater than or equal to about 20 mol % to less than or equal to about 99 mol % of a monomer;
greater than or equal to about 0 mol % to less than or equal to about 10 mol % of a cationic photoinitiator; and
greater than or equal to about 0 mol % to less than or equal to about 70 mol % of an optional diluent.

20. A fiber-reinforced composite comprising:
one or more layers, the one or more layers each comprising a fiber material and a first compound; and
a second compound disposed on or adjacent to the one or more layers, the second compound including a photosensitizer.
